(19) United States
(12) Patent Application Publication
(10) Pub. No.: US 2026/0347529 A1
(43) Pub. Date: Nov. 5, 2026

(54) SILICONE LEATHER COATING COMPOSITION THEREOF

(71) Applicants: Dow Silicones Corporation, Midland, MI (US); Dow Global Technologies LLC, Midland, MI (US)

(72) Inventors: Yusheng Chen, Shanghai (CN); Huangguan Chen, Shanghai (CN); Xi Chen, Shanghai (CN); Rui Wang, Shanghai (CN); Tingting Chen, Shanghai (CN); Yi Guo, Shanghai (CN); Qing Shi, Shanghai (CN)

(21) Appl. No.: 19/491,524

(22) PCT Filed: Jun. 28, 2023
(86) PCT No.: PCT/CN2023/103017

§ 371 Date: Dec. 9, 2025

(30) Foreign Application Priority Data
Jun. 28, 2023 (WO) PCT/CN23/103017

(51) Int. Cl. C08G 18/12; C08G 18/48; C08G 18/61; D06N 3/00; D06N 3/12; D06N 3/14; D06N 3/18

(52) U.S. Cl. CPC C08G 18/12; C08G 18/4829; C08G 18/61; D06N 3/0097; D06N 3/128; D06N 3/14; D06N 3/183; C08G 2150/00; D06N 2203/066; D06N 2203/068; D06N 2205/20; D06N 2209/1642

(57) ABSTRACT

The present disclosure relates to a method for preparing a carbinol terminated silicone/polyurethane hybrid prepolymer based coating composition (v) comprising the steps of (A) Preparing a carbinol terminated silicone/polyurethane hybrid prepolymer; and (B) preparing the carbinol terminated silicone/polyurethane hybrid prepolymer based coating composition (v) by mixing the carbinol terminated silicone/polyurethane hybrid prepolymer produced in (A) ((v) (a)) with optional cured silicone elastomer powder (v) (b); optional silicon-free organic particles and/or microparticles (v) (c); a polyorganosiloxane containing at least two or alternatively at least three silicon bonded hydrogen (—Si—H) groups per molecule (v) (d); a polyisocyanate having three or more isocyanate groups per molecule in an amount such that the molar ratio of —OH groups of (v) (a) to —NCO groups in (v) (f) in the carbinol terminated silicone/polyurethane hybrid prepolymer based coating composition (v) is from 0.95:1 to 1.05:1; and a platinum group metal-based catalyst (v) (g). The carbinol terminated silicone/polyurethane hybrid prepolymer based coating composition is prepared for use in a silicone leather composite material.

The present disclosure relates to a method for preparing a carbinol terminated silicone/polyurethane hybrid prepolymer based coating composition (v) comprising the steps of
(A) Preparing a carbinol terminated silicone/polyurethane hybrid prepolymer; and
(B) preparing the carbinol terminated silicone/polyurethane hybrid prepolymer based coating composition (v) by mixing the carbinol terminated silicone/polyurethane hybrid prepolymer produced in (A) (component (v)(a)) with optional cured silicone elastomer powder (v)(b); optional silicon-free organic particles and/or microparticles (v)(c); a polyorganosiloxane containing at least two or alternatively at least three silicon bonded hydrogen (—Si—H) groups per molecule (v)(d); a polyisocyanate crosslinker having three or more isocyanate groups per molecule (v)(f) in an amount such that the molar ratio of —OH groups of (v)(a) to —NCO groups in (v)(f) in the carbinol terminated silicone/polyurethane hybrid prepolymer based coating composition (v) is from 0.95:1 to 1.05:1; and a platinum group metal-based catalyst (v)(g). The carbinol terminated silicone/polyurethane hybrid prepolymer based coating composition is prepared for use in a silicone leather composite material.

A variety of synthetic alternatives to natural leather have been developed with polyurethane (PU) or polyvinylchloride (PVC) based materials having been mainly used. They are used in a wide variety of applications including for furniture, decoration, handbags, luggage, garments, footwear, car interiors, car seats and the like. However, to meet increasingly strict safety regulations, to be utilised as synthetic leather, they need to meet stringent physical property requirements, regarding e.g., flame retardancy, smoke density, suitable adhesion strength in order to prevent a coating layer to be peeled off at the time of usage, heat resistance, contamination resistance, solvent resistance, hydrolysis resistance, and the like, are required. Often the PU and/or PVC based materials cannot satisfy one or more of the above-mentioned physical property requirements.

Silicone-based leather composite materials provide further synthetic alternatives to natural leather.

Such silicone-based leather composite materials can have several advantages over the PU and/or PVC based synthetic leather materials discussed above. For example, they can be prepared using more eco-friendly production methods, using no plasticizer(s), toxic heavy metal(s) or environmentally problematic solvents such as dimethylformamide (DMF) which often remain, at least partially, in the synthetic PU and/or PVC leather products post manufacture.

Silicone-based leather composite materials may be made via several routes but are generally manufactured using a textile support layer and two or more layers of hydrosilylation curable liquid silicone rubber compositions and a release paper. For example, a first liquid silicone rubber (LSR) composition may be coated onto a release paper and is then cured to form a first or skin layer. A second LSR composition, usually having different physical properties to that of the first, is adhered to the cured first layer to form an adhesion layer and a textile support layer is adhered to the second LSR layer prior to cure, after which the second LSR composition is cured to form a binder layer situated between the skin layer and the textile support layer. One or more additional layers of hydrosilylation curable silicone elastomer compositions may also be applied between the release paper and the textile layer as deemed appropriate to form a silicone-based leather composite material. For example, a third layer may be provided as a protective topcoat on top of the skin layer. The release paper is subsequently removed as and when required.

Such silicone-based leather composite materials are able to outperform conventional PU and PVC synthetic leather, from a physical property perspective because of the ability to provide, for example, better flexibility over a broad temperature range as well as excellent UV resistance, thermal resistance and flame retardancy. Topcoats are particularly important as they help to provide advantageous properties such as soil resistance as well as being both kind to the human skin and providing an excellent hand-feeling for users.

However, due to intrinsically weak intermolecular interaction between polysiloxane chains, silicone offerings suffer from poor mechanical strength and thus poor abrasion resistance. Therefore, the use of silicone leather composite materials tends to be limited to application scenarios with low abrasion resistant requirements, whilst PU and PVC synthetic leathers are often used in applications requiring good anti-abrasion resistance, such as in automotive interiors.

There remains a need therefore to provide silicone leather composite materials with improved abrasion resistance, whilst retaining the physical property advantages compared with PU and PVC based synthetic leathers.

There is provided a method for preparing a carbinol terminated silicone/polyurethane hybrid prepolymer based coating composition comprising the steps of
(A) Preparing a carbinol terminated silicone/polyurethane hybrid prepolymer by mixing together
(I) A diisocyanate in an amount of 20 to 30 wt. % of the step (A) starting ingredients,
(II) an alkane diol chain extender in an amount of from 5 to 15 wt. % of the step (A) starting ingredients
(III) a carbinol terminated polydimethylsiloxane in an amount of from 25 to 45 wt. % of the step (A) starting ingredients
(IV) a solvent in an amount of from 20 to 40 wt. % of the step (A) starting ingredients, and optionally
(V) a polyether triol in an amount of up to 2 wt. % of the step (A) starting ingredients
wherein the molar ratio of OH:NCO is greater than 1.15:1;
by gradually introducing a suitable catalyst while heating the mixture to a predetermined reaction temperature of from 60 to 90 °C and continuing to stir the mixture for a pre-determined time of at least 90 minutes whilst maintaining the mixture at the predetermined reaction temperature and then cooling the reaction product of carbinol terminated silicone/polyurethane hybrid prepolymer; and
(B) preparing the carbinol terminated silicone/polyurethane hybrid prepolymer based coating composition (v) by mixing
(v)(a) the carbinol terminated silicone/polyurethane hybrid prepolymer with
(v)(b) optional cured silicone elastomer powder;
(v)(c) optional silicon-free organic particles and/or microparticles selected from at least one of polymethyl methacrylate (PMMA), ethylene-vinyl acetate copolymer (EVA), ethylene-acrylate copolymer (EAA), ethylene-butyl acrylate copolymer (EBA), ethylene-methyl acrylate copolymer (EMA), ethylene-ethyl acrylate copolymer (EEA) or polyurethane polymer;
(v)(d) a polyorganosiloxane containing at least two or alternatively at least three silicon bonded hydrogen (—Si—H) groups per molecule present in an amount of from 1 wt. %-10 wt. % of the composition;
(v)(f) a polyisocyanate crosslinker having three or more isocyanate groups per molecule in an amount such that the molar ratio of —OH groups of (v)(a) to —NCO groups in (v)(f) in the carbinol terminated silicone/polyurethane hybrid prepolymer based coating composition (v) is from 0.95:1 to 1.05:1; and
(v)(g) a platinum group metal-based catalyst.

There is provided a method for preparing a carbinol terminated silicone/polyurethane hybrid prepolymer based coating composition comprising mixing
(v)(a) a carbinol terminated silicone/polyurethane hybrid prepolymer with
(v)(b) optional cured silicone elastomer powder;
(v)(c) optional silicon-free organic particles and/or microparticles selected from at least one of polymethyl methacrylate (PMMA), ethylene-vinyl acetate copolymer (EVA), ethylene-acrylate copolymer (EAA), ethylene-butyl acrylate copolymer (EBA), ethylene-methyl acrylate copolymer (EMA), ethylene-ethyl acrylate copolymer (EEA) or polyurethane polymer;
(v)(d) a polyorganosiloxane containing at least two or alternatively at least three silicon bonded hydrogen (—Si—H) groups per molecule present in an amount of from 1 wt. %-10 wt. % of the composition;
(v)(f) a polyisocyanate crosslinker having three or more isocyanate groups per molecule in an amount such that the molar ratio of —OH groups of (v)(a) to —NCO groups in (v)(f) in the carbinol terminated silicone/polyurethane hybrid prepolymer based coating composition (v) is from 0.95:1 to 1.05:1; and
(v)(g) a platinum group metal-based catalyst.

In one embodiment the carbinol terminated silicone/polyurethane hybrid prepolymer is prepared in a first step A by mixing together
(I) A diisocyanate in an amount of 20 to 30 wt. % of the step (A) starting ingredients,
(II) an alkane diol chain extender in an amount of from 5 to 15 wt. % of the step (A) starting ingredients
(III) a carbinol terminated polydimethylsiloxane in an amount of from 25 to 45 wt. % of the step (A) starting ingredients
(IV) a solvent in an amount of from 20 to 40 wt. % of the step (A) starting ingredients, and optionally
(V) a polyether triol in an amount of up to 2 wt. % of the step (A) starting ingredients
wherein the molar ratio of OH:NCO is greater than 1.15:1;
by gradually introducing a suitable catalyst while heating the mixture to a predetermined reaction temperature of from 60 to 90 °C and continuing to stir the mixture for a pre-determined time of at least 90 minutes whilst maintaining the mixture at the predetermined reaction temperature and then cooling the reaction product of carbinol terminated silicone/polyurethane hybrid prepolymer; prior to the above step, step B, preparing a carbinol terminated silicone/polyurethane hybrid prepolymer based coating composition.

For the avoidance of doubt the molar ratio of OH:NCO is greater than 1.15:1 relates to the total —OH content of all starting ingredients i.e., the cumulative molar ratio of the —OH content of components (II), (III), (IV) when the solvent contains —OH groups and (V) when present: the NCO groups of component (I).

The carbinol terminated silicone/polyurethane hybrid prepolymer based coating composition is prepared for use in a silicone leather composite material comprising
(i) A textile support layer;
(ii) A silicone binder, wherein the silicone binder is the cured product of a 2-part hydrosilylation curable silicone rubber composition designed to adhere to the textile support layer (i) and the skin layer (iii), which has a shore A hardness of from 20 to 40 measured in accordance with ASTM D2240;
(iii) A silicone skin layer, wherein the silicone skin layer is the cured product of a 2-part hydrosilylation curable silicone rubber composition comprising an adhesion promoter, which silicone skin layer has a shore A hardness greater than or equal to (≥) 50 when measured in accordance with ASTM D2240;
(iv) a silicone topcoat layer wherein the silicone topcoat layer is the cured product of a 2-part hydrosilylation curable silicone topcoat which comprises an adhesion promoter; and
(v) the silicone/polyurethane hybrid prepolymer based coating layer;
wherein the silicone binder (ii) is adhered between textile support (i) and the skin layer (iii), the skin layer (iii) is between the silicone binder layer (ii) and the silicone/polyurethane hybrid prepolymer based coating layer and silicone topcoat layer (iv) is on the silicone/polyurethane hybrid prepolymer based coating layer (v).

There is also provided a carbinol terminated silicone/polyurethane hybrid prepolymer based coating composition obtained or obtainable by the method described above.

There is also provided a carbinol terminated silicone/polyurethane hybrid prepolymer based coating composition (v) comprising
(v)(a) the carbinol terminated silicone/polyurethane hybrid prepolymer with
(v)(b) optional cured silicone elastomer powder;
(v)(c) optional silicon-free organic particles and/or microparticles selected from at least one of polymethyl methacrylate (PMMA), ethylene-vinyl acetate copolymer (EVA), ethylene-acrylate copolymer (EAA), ethylene-butyl acrylate copolymer (EBA), ethylene-methyl acrylate copolymer (EMA), ethylene-ethyl acrylate copolymer (EEA) or polyurethane polymer;
(v)(d) a polyorganosiloxane containing at least two or alternatively at least three silicon bonded hydrogen (—Si—H) groups per molecule present in an amount of from 1 wt. %-10 wt. % of the composition;
(v)(f) a polyisocyanate crosslinker having three or more isocyanate groups per molecule in an amount such that the molar ratio of —OH groups of (v)(a) to —NCO groups in (v)(f) in the carbinol terminated silicone/polyurethane hybrid prepolymer based coating composition (v) is from 0.95:1 to 1.05:1; and
(v)(g) a platinum group metal-based catalyst.

There is also provided a method for preparing a carbinol terminated silicone/polyurethane hybrid prepolymer by mixing together
(I) a diisocyanate in an amount of 20 to 30 wt. % of the step (A) starting ingredients,
(II) an alkane diol chain extender in an amount of from 5 to 15 wt. % of the step (A) starting ingredients
(III) a carbinol terminated polydimethylsiloxane in an amount of from 25 to 45 wt. % of the step (A) starting ingredients
(IV) a Solvent in an amount of from 20 to 40 wt. % of the step (A) starting ingredients, and optionally
(V) a polyether triol in an amount of up to 2 wt. % of the step (A) starting ingredients
wherein the molar ratio of OH:NCO is greater than 1.15:1; by gradually introducing a suitable catalyst while heating the mixture to a predetermined reaction temperature of from 60 to 90 °C and continuing to stir the mixture for a pre-determined time of at least 90 minutes whilst maintaining the mixture at the predetermined reaction temperature and then cooling the reaction product of carbinol terminated silicone/polyurethane hybrid prepolymer.

There is provided a carbinol terminated silicone/polyurethane hybrid prepolymer obtained or obtainable by the method above.

There is also provided the use of a carbinol terminated silicone/polyurethane hybrid prepolymer as described above in a carbinol terminated silicone/polyurethane hybrid prepolymer based coating composition as described above for a silicone leather composite material comprising
(i) A textile support layer;
(ii) A silicone binder, wherein the silicone binder is the cured product of a 2-part hydrosilylation curable silicone rubber composition designed to adhere to the textile support layer (i) and the skin layer (iii), which has a shore A hardness of from 20 to 40 measured in accordance with ASTM D2240;
(iii) A silicone skin layer, wherein the silicone skin layer is the cured product of a 2-part hydrosilylation curable silicone rubber composition comprising an adhesion promoter, which silicone skin layer has a shore A hardness greater than or equal to (≥) 50 when measured in accordance with ASTM D2240;
(iv) a silicone topcoat layer wherein the silicone topcoat layer is the cured product of a 2-part hydrosilylation curable silicone topcoat which comprises an adhesion promoter; and
(v) the silicone/polyurethane hybrid prepolymer based coating layer;
wherein the silicone binder (ii) is adhered between textile support (i) and the skin layer (iii), the skin layer (iii) is between the silicone binder layer (ii) and the silicone/polyurethane hybrid prepolymer based coating layer and silicone topcoat layer (iv) is on the silicone/polyurethane hybrid prepolymer based coating layer (v).

In one embodiment the silicone/polyurethane hybrid prepolymer based coating layer (v) is a carbinol terminated silicone/polyurethane hybrid prepolymer based prepolymer based coating layer which has a modulus at 100% extension equal to or greater than 10 MPa determined in accordance with ASTM D882.

A silicone leather composite material comprising
(i) A textile support layer;
(ii) A silicone binder, wherein the silicone binder is the cured product of a 2-part hydrosilylation curable silicone rubber composition designed to adhere to the textile support layer (i) and the skin layer (iii), which has a shore A hardness of from 20 to 40 measured in accordance with ASTM D2240;
(iii) A silicone skin layer, wherein the silicone skin layer is the cured product of a 2-part hydrosilylation curable silicone rubber composition comprising an adhesion promoter, which silicone skin layer has a shore A hardness greater than or equal to (≥) 50 when measured in accordance with ASTM D2240;
(iv) a silicone topcoat layer wherein the silicone topcoat layer is the cured product of a 2-part hydrosilylation curable silicone topcoat which comprises an adhesion promoter; and
(v) a silicone/polyurethane hybrid prepolymer based coating layer which is the cured product of the silicone/polyurethane hybrid prepolymer based coating composition described above;
wherein the silicone binder (ii) is adhered between textile support (i) and the skin layer (iii), the skin layer (iii) is between the silicone binder layer (ii) and the silicone/polyurethane hybrid prepolymer based coating layer and silicone topcoat layer (iv) is on the silicone/polyurethane hybrid prepolymer based coating layer (v).

There is also provided a method for preparing the silicone leather composite material as identified above comprising the steps of

Firstly, preparing the prepolymer as described above, secondly preparing the carbinol terminated silicone/polyurethane hybrid prepolymer based coating composition as described above and then
(a) coating a release paper with a layer of carbinol terminated silicone/polyurethane hybrid prepolymer based coating composition comprising
(v)(a) a carbinol terminated silicone/polyurethane hybrid prepolymer;
(v)(b) optional cured silicone elastomer powder;
(v)(c) optional silicon-free organic particles and/or microparticles selected from at least one of polymethyl methacrylate (PMMA), ethylene-vinyl acetate copolymer (EVA), ethylene-acrylate copolymer (EAA), ethylene-butyl acrylate copolymer (EBA), ethylene-methyl acrylate copolymer (EMA), ethylene-ethyl acrylate copolymer (EEA) or polyurethane polymer;
   and curing said composition to provide a carbinol terminated silicone/polyurethane hybrid prepolymer based coating layer (v);
(b) Applying a layer of a silicone skin composition on to the cured carbinol terminated silicone/polyurethane hybrid prepolymer based coating layer (v) and curing said composition to provide a silicone skin layer (iii);
(c) Applying a layer of silicone binder composition onto cured silicone skin layer (iii) and applying a textile layer (i) onto the silicone binder composition and curing and/or laminating said composition to form a silicone binder layer (ii) between said textile support layer (i) and said skin layer (iii);
(d) Removing the release paper from the cured carbinol terminated silicone/polyurethane hybrid prepolymer based coating layer (v); and
(e) Applying a layer of a 2-part hydrosilylation curable silicone topcoat composition onto the cured carbinol terminated silicone/polyurethane hybrid prepolymer based coating layer (v) and curing said topcoat composition to form a silicone topcoat layer (iv).

### The Carbinol Terminated Silicone/Polyurethane Hybrid Prepolymer

The carbinol terminated silicone/polyurethane hybrid prepolymer is prepared from the following starting ingredients
(I) a diisocyanate in an amount of 20 to 30 wt. % of the step (A) starting ingredients,
(II) an alkane diol chain extender in an amount of from 5 to 15 wt. % of the step (A) starting ingredients
(III) a carbinol terminated polydimethylsiloxane in an amount of from 25 to 45 wt. % of the step (A) starting ingredients
(IV) a Solvent in an amount of from 20 to 40 wt. % of the step (A) starting ingredients and optionally
(V) a polyether triol in an amount of up to 2 wt. % of the step (A) starting ingredients wherein the molar ratio of OH:NCO is greater than 1.15:1.

For the avoidance of doubt, it is to be understood that the carbinol terminated silicone/polyurethane hybrid prepolymer described herein is one in which all isocyanate groups have been reacted with carbinol groups leaving carbinol functionality as the terminal groups and not isocyanate terminal groups and as previously indicated the molar ratio of OH:NCO is greater than 1.15:1 relates to the total —OH content of all starting ingredients i.e., the cumulative molar ratio of the —OH content of components (II), (III), (IV) when the solvent contains —OH groups and (V) when present: the NCO groups of component (I).

Diisocyanate Component (I) The diisocyanate component (I) may be any suitable aromatic diisocyanate such as polymethylene polyphenyl diisocyanate, diphenylmethane diisocyanate, polymeric diphenylmethane diisocyanate, carbodiimide-modified diphenylmethane diisocyanate, xylylene diisocyanate, phenylene diisocyanate, tolylene diisocyanate, and naphthalene diisocyanate; or
an aliphatic or alicyclic polyisocyanate such as hexamethylene diisocyanate, lysine diisocyanate, cyclohexane diisocyanate, isophorone diisocyanate (IPDI), dicyclohexylmethane diisocyanate, and tetramethyl xylylene diisocyanate; or a mixture of two or more thereof may be used.

Aliphatic or alicyclic diisocyanates are preferred e.g., IPDI. Diisocyanate component (I) is present in the starting ingredients for making the carbinol terminated silicone/polyurethane hybrid prepolymer in an amount of 20 to 30 wt. %, alternatively 20 to 26 wt. %. It was found that the starting ingredients needed to comprise at least 20 wt. % of the diisocyanate in order to ensure good Gakushin abrasion resistance results on the silicone leather composite material (Gakushin testing apparatus are used to assess abrasion resistance of leather, fabric, vinyl, stitched seams, plastics and other materials).

### Alkane Diol Chain Extender (II)

The alkane diol chain extender (II) is a short chain organic diol having from 2 to 6 carbons per molecule, such as ethylene glycol, 1,3-propanediol and/or 1,4-butanediol. The hydroxyl content of alkane diol chain extender (II) may be determined in accordance with ASTM-D4274-11. The alkane diol is present in the starting ingredients for making the carbinol terminated silicone/polyurethane hybrid prepolymer in an amount of 5 to 15 wt. %, alternatively 6 to 13 wt. 5, alternatively 7 to 11 wt. %.

### Carbinol Terminated Polydialkylsiloxane Polymer (III)

Typically, the carbinol terminated polydialkylsiloxane polymer (III) has a hydroxyl value equal to or greater than 40 mg KOH/g measured in accordance with ASTM-D4274-11 and is a carbinol terminated polydimethylsiloxane polymer.

For the avoidance of doubt, a terminal carbinol (C—OH) group is a C—OH group linked to a terminal silicon via a suitable non-hydrolysable organic linkage for example the following:

—Z⁵_{z′}-D_{d}-OH
Where Z⁵ is a divalent alkylene group comprising 1 to 6 carbons, alternatively 2 to 6 carbons, alternatively 2 to 4 carbons and z′ is 0 or 1 and D is one or more linear or branched polyethers comprising repeating units having the average formula (—O—C_{n′}H_{2n′}) wherein n′ is an integer from 2 to 6 inclusive and d is an integer of from 1 to 6, alternatively 2 to 4. Suitable commercially available carbinol terminated polydimethylsiloxanes include, for the sake of example, DOWSIL™ BY16-201 from Dow Silicones Corporation or KF-6000 and KF-6001 from Shin-Etsu Chemical Co. Ltd. The carbinol terminated polydialkylsiloxane polymer is present in the starting ingredients for making the carbinol terminated silicone/polyurethane hybrid prepolymer in an amount of from 25 to 45 wt. %, alternatively from 25 to 42 wt. %, alternatively from 25 to 40 wt. %, alternatively from 25 to 38 wt. %, alternatively from 30 to 38 wt. %. It was found that the presence of greater than 45 wt. % carbinol terminated polydialkylsiloxane polymer would also lead to poor Gakushin abrasion resistance results (less than 4500). In one alternative no more than 42 wt. % of the carbinol terminated polydialkylsiloxane polymer, alternatively no more than 38 wt. % carbinol terminated polydialkylsiloxane polymer is utilised, in each case to ensure a good Gakushin abrasion resistance result of at least 5000.

### Solvent (IV)

Any suitable solvent may be used as solvent (IV). Preferably the solvent (IV) does not contain any —OH groups, alternatively solvent (IV) does not contain any —OH groups. The solvent is an essential ingredient because without solvent present the overall viscosity of the starting ingredients is too high to ensure good mixing. Examples of suitable solvents include a glycol ether such as ethylene glycol dimethyl ether (CH₃O(CH₂)₂OCH₃), ethylene glycol dibutyl ether and/or one or more esters of glycol ethers such as (but not limited to) ethylene glycol methyl ether acetate, ethylene glycol monoethyl ether acetate, ethylene glycol monopropyl ether acetate, ethylene glycol monobutyl ether acetate, propylene glycol monomethyl ether acetate, propylene glycol diacetate and dipropylene glycol monoethyl ether acetate. dipropylene glycol methyl ether acetate (DPMA) which has the following structure:

CH₃OCH₂CH(CH₃)OC(═O)CH₃

If the solvent does contain —OH groups, these —OH groups are included in the molar ratio calculation of —OH groups:NCO groups and said —OH groups would potentially interact with NCO groups during the polymerisation process, hence the preference for their absence to ensure the solvent is able to evaporate and not participate in chemical reactions with the NCO groups.

### Polyether Triol (V)

Component (V) is optional and is a polyether triol in an amount of up to 2 wt. % of the step (A) starting ingredients. Component (V) may be any suitable polyether triol. For example, the polyether triol (V) may be:
a polyether triol having a hydroxyl value of from 647-676 mg KOH/g sold under the trade name VORANOL™ CP 260 Polyol from the Dow Chemical company or
a polyether triol having a hydroxyl value of from 370-396 mg KOH/g sold under the trade name VORANOL™ CP 450 Polyol from the Dow Chemical company or
a polyether polyol HF-302 commercially available from Zhejiang Hengfeng New Material Co., Ltd.

As previously indicated, the molar ratio of OH:NCO is greater than 1.15:1. This molar ratio relates to the total —OH content of all starting ingredients i.e., the cumulative molar ratio of the —OH content of components (II), (III), (IV) when the solvent contains —OH groups and (V) when present: the NCO groups of component (I).

As indicated above typically the solvent does not contain any —OH groups and of course the polyether triol component (V) is optional so typically the molar ratio of OH:NCO relates to the cumulative molar ratio of the —OH content of components (II) and (III) when solvent (IV) contains no —OH groups and when component (V) is omitted or the —OH content of components (II) (III) (V) when present and solvent (IV) contains no —OH groups but equally can relates to the —OH content of components (II), (III), (IV) and (V) when they all contain —OH groups.

The carbinol terminated silicone/polyurethane hybrid prepolymer is prepared by gradually introducing a suitable catalyst while heating the mixture of the above starting ingredients to a predetermined reaction temperature of from 60 to 90 °C, alternatively 60 to 80 °C and continuing to stir the mixture for a pre-determined time of at least 90 minutes, alternatively from 2 to 5 hours whilst maintaining the mixture at the predetermined reaction temperature and then cooling the reaction product of carbinol terminated silicone/polyurethane hybrid prepolymer.

### Catalyst

Any suitable catalyst(s) for catalysing the preparation of the aforementioned prepolymer may be utilised. Examples of suitable catalysts for catalysing the preparation of the aforementioned prepolymer include, but are not limited to, suitable known polyurethane catalysts such as those of tin, bismuth, zinc, mercury or a mixture of Sn, Bi, Zn, Hg such as a suitable Bi/Zn catalyst. Examples include carboxylates of tin, bismuth, zinc and/or mercury.

Suitable tin catalyst may include, for the sake of example, tin triflates, organic tin metal catalysts such as triethyltin tartrate, tin octoate, tin oleate, tin naphthenate, butyltintri-2-ethylhexoate, tin butyrate, carbomethoxy phenyl tin trisuberate, isobutyltintriceroate, and diorganotin salts especially diorganotin dicarboxylate compounds such as dibutyltin dilaurate (DBTDL), dioctyltin dilaurate (DOTDL), dimethyltin dibutyrate, dibutyltin dimethoxide, dibutyltin diacetate (DBTDA), dibutyltin bis(2,4-pentanedionate), dibutyltin dibenzoate, stannous octoate, dimethyltin dineodecanoate (DMTDN) dioctyltin dineodecanoate (DOTDN) and dibutyltin dioctoate. A commercial example of the tin catalyst (v)(e) is a dibutyltin dilaurate based catalyst commercially available under the trade name Dabco® T-12 from Evonik.

Alternatively, the catalyst may be a suitable Bi/Zn catalyst, such as and is commercially available under the trade name BX-EM 23 from Guangzhou Yourun Synthetic Material Co., Ltd of Guang Dong, China.

The carbinol terminated silicone/polyurethane hybrid prepolymer prepared in accordance with the above process can then be utilised in step B the preparation of the carbinol terminated silicone/polyurethane hybrid prepolymer based coating composition.

Unexpectedly, it had been found that —NCO terminated silicone/polyurethane hybrid prepolymers prepared by the reaction of a diisocyanate such as isophorone diisocyanate (IPDI) with a carbinol terminated polydimethylsiloxane polymer and optionally a diol such as 1,4-butanediol (BDO) in an eco-solvent with an excess of diisocyanate to ensure —NCO termination, were not stable for long term storage, e.g., for greater than 2 months and tended to gel, whilst carbinol terminated silicone/polyurethane hybrid prepolymers as described herein were able to be stored without gelling for much longer periods of time.

The solute ingredients (i.e., ingredients excluding the solvent) of the carbinol terminated silicone/polyurethane hybrid prepolymer based coating composition are as follows
(v)(a) the carbinol terminated silicone/polyurethane hybrid prepolymer described above with
(v)(b) optional cured silicone elastomer powder;
(v)(c) optional silicon-free organic particles and/or microparticles selected from at least one of polymethyl methacrylate (PMMA), ethylene-vinyl acetate copolymer (EVA), ethylene-acrylate copolymer (EAA), ethylene-butyl acrylate copolymer (EBA), ethylene-methyl acrylate copolymer (EMA), ethylene-ethyl acrylate copolymer (EEA) or polyurethane polymer;
(v)(d) a polyorganosiloxane containing at least two or alternatively at least three silicon bonded hydrogen (—Si—H) groups per molecule present in an amount of from 1 wt. %-10 wt. % of the composition;
(v)(f) polyisocyanate crosslinker having three or more isocyanate groups per molecule in an amount such that the molar ratio of —OH groups of (v)(a) to —NCO groups in (v)(f) in the carbinol terminated silicone/polyurethane hybrid prepolymer based coating composition (v) is from 0.95:1 to 1.05:1; and
(v)(g) a platinum group metal-based catalyst.

In step (B) herein the carbinol terminated silicone/polyurethane hybrid prepolymer based coating composition (v) in step (B) is undertaken by mixing the above ingredients together.

The optional cured silicone elastomer powder (v)(b) may be selected from the same particles as described with respect to component (g) of the silicone topcoat (iv) in the silicone leather composite material described in detail below.

The (v)(c) optional silicon-free organic particles and/or microparticles (v)(c) are selected from at least one of polymethyl methacrylate (PMMA), ethylene-vinyl acetate copolymer (EVA), ethylene-acrylate copolymer (EAA), ethylene-butyl acrylate copolymer (EBA), ethylene-methyl acrylate copolymer (EMA), ethylene-ethyl acrylate copolymer (EEA) or polyurethane polymer; alternatively, the silicon-free organic particles and/or microparticles (v)(c) are selected from PMMA and/or polyurethane particles and/or microparticles.

For the avoidance of doubt the silicon-free organic particles or microparticles are silicon-free, allowing only for trace contamination, i.e., the silicon-free organic microparticles contain substantially no silicon atoms or silicon containing compounds. In one alternative the silicon-free organic particles or microparticles have a number average particle size of from 0.5 to 500 μm determined using a field emission scanning electron microscope such as an FEI Nova NanoSEM™ 630 scanning electron microscope from Thermo Fisher Scientific. For example, this may be achieved by taking a field emission scanning electron microscope photograph of the particles and then selecting ten particles randomly from the photograph and measuring the diameter of each of particle in the images Then the average diameter is calculated for the particles selected. The silicon-free organic particles or microparticles are preferably thermally stable up to a temperature of at least 180 °C. They are required to be thermally stable throughout the cure process which is typically held at a temperature between 80 °C and 180 °C. By “thermally stable” we mean that the silicon-free organic particles or microparticles do not thermally degrade at temperatures at or below 180 °C. This is determined by placing a sample of silicon-free organic particles or microparticles in a suitable container and then placing the container into a preheated oven at a temperature of 180 °C. and atmospheric pressure, for a period of 30 minutes. After the 30 minutes in the oven the sample is visually assessed to determine whether the particles or microparticles appear to be in their original form in which case they are deemed thermally stable up to a temperature of 180 °C. (pass) or whether they have visually degraded in some way which is visually evident e.g., by agglomeration, liquefaction, carbonization and/or decomposition.

In a preferred embodiment the total amount of particles in the carbinol terminated silicone/polyurethane hybrid prepolymer based coating composition used to prepare the carbinol terminated silicone/polyurethane hybrid prepolymer based coating layer (v), in wt. % thereof i.e., (v)(b)+(v)(c) is from 10 wt. %-40 wt. % of the composition.

The polyorganosiloxane containing at least two or alternatively at least three silicon bonded hydrogen (—Si—H) groups per molecule (v)(d) may be selected from any one of the cross-linkers defined in component (c) of the silicone topcoat (iv) in the silicone leather composite material described in detail below and is typically present in an amount of from 1 wt. %-10 wt. % of the composition used to prepare the aforementioned carbinol terminated silicone/polyurethane hybrid prepolymer based coating layer (v) but is preferably a resinous cross-linker for example, be an MQ resin having Si—H dimethyl terminal groups such as Si—H dimethyl terminal groups polysiloxane having a viscosity of 25 mPa·s at 25 °C and a silicon bonded hydrogen content of about 9,000 ppm.

The polyisocyanate crosslinker having three or more isocyanate groups per molecule (v)(f) is present in an amount such that the molar ratio of —OH groups of (v)(a) to —NCO groups in (v)(f) in the carbinol terminated silicone/polyurethane hybrid prepolymer based coating composition (v) is from 0.95:1 to 1.05:1. The polyisocyanate having three or more isocyanate groups per molecule may be an aliphatic polyisocyanate trimer such as one of the following

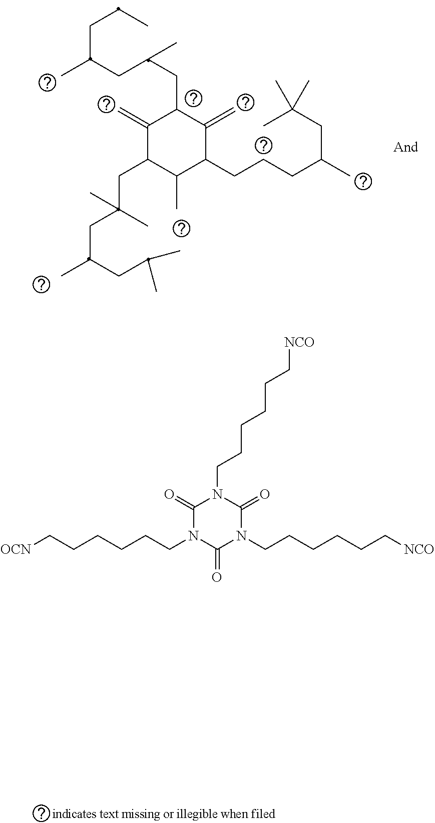

or the like.

The polyisocyanate having three or more isocyanate groups per molecule (v)(f) content is approximately 10 wt. %-30 wt. % in the carbinol terminated silicone/polyurethane hybrid prepolymer based coating composition used to prepare the aforementioned carbinol terminated silicone/polyurethane hybrid prepolymer based coating layer (v), however this may vary dependent on the number of NCO groups per molecule given the required molar ratio given above.
and

The platinum group metals of the platinum group metal-based catalyst are platinum, ruthenium, osmium, rhodium, iridium and palladium, or a compound of such metals. Typically, platinum group metals-based catalyst (v)(g) is a platinum or ruthenium-based catalyst alternatively a platinum-based catalyst as described with respect to component (d) of the silicone topcoat (iv) in the silicone leather composite material with Karstedt's catalyst being preferred.

Optional Cure Catalyst (v)(e)

The carbinol terminated silicone/polyurethane hybrid prepolymer based coating composition (v) may also comprise an optional cure catalyst (v)(e) for curing the carbinol terminated silicone/polyurethane hybrid prepolymer based coating composition; The optional polyurethane cure catalyst (v)(e) when present may be selected from any of the catalysts utilised in the preparation of the o carbinol terminated silicone/polyurethane hybrid prepolymer described above.

When present, the optional polyurethane cure catalyst (v)(e) may be present in an amount of from 0.01 to 3 wt. % of the composition; alternatively, 0.03 to 1.5 wt. % of the carbinol terminated silicone/polyurethane hybrid prepolymer based coating composition, alternatively, 0.03 to 0.75 wt. % of the composition.

Surprisingly, it was also found that the use of an —NCO terminated silicone/polyurethane hybrid prepolymer to make a silicone/polyurethane hybrid prepolymer based composition which relied on a tri-functional polyol (crosslinker) also tended to gel in storage whereas the carbinol terminated silicone/polyurethane hybrid prepolymer based coating composition (v) is far more stable in storage for longer periods of time.

The carbinol terminated silicone/polyurethane hybrid prepolymer based coating composition is prepared in a suitable solvent and the solvent evaporates during a heated curing process. Any suitable solvent may be utilised to assist in the preparation of the carbinol terminated silicone/polyurethane hybrid prepolymer based coating composition but is typically chosen such that it will evaporate during the cure process. The solvent is preferably selected from those solvents defined as solvent (IV) used in the preparation of the carbinol terminated silicone/polyurethane hybrid prepolymer.

The carbinol terminated silicone/polyurethane hybrid prepolymer based coating composition may be prepared in any way desired.

The carbinol terminated silicone/polyurethane hybrid prepolymer based coating composition described above and used to prepare the aforementioned carbinol terminated silicone/polyurethane hybrid prepolymer based coating layer (v) is stored in two parts a first part and a second part. The polyisocyanate having three or more isocyanate groups per molecule (v)(f), and platinum group metal-based catalyst (v)(g) are kept apart from the rest of the ingredients during storage (in the second part). The aforementioned optional tin or Bi/Zn catalyst (v)(e), when present, may be in the first part or the second part and all remaining ingredients are retained in the first part until mixed together.

The carbinol terminated silicone/polyurethane hybrid prepolymer based coating composition described above is present in an amount such that the molar ratio of —OH groups of (v)(a) to —NCO groups in (v)(f) in the carbinol terminated silicone/polyurethane hybrid prepolymer based coating composition (v) is from 0.95:1 to 1.05:1, and is designed such that the carbinol terminated silicone/polyurethane hybrid prepolymer (v)(a) reacts with the polyisocyanate having three or more isocyanate groups per molecule (v)(f) in combination with the other ingredients of the composition. which reaction/cure process takes place at any suitable temperature such as from 100 to 160 °C, alternatively from 120 to 150 °C.

The carbinol terminated silicone/polyurethane hybrid prepolymer based coating composition may be cured at a temperature of from 100 °C-200 °C. temperature such as from 100 to 160 °C, alternatively from 120 to 150 °C for 2-10 minutes.

As previously discussed, the carbinol terminated silicone/polyurethane hybrid prepolymer based coating composition is prepared for use in a silicone leather composite material comprising
(i) A textile support layer;
(ii) A silicone binder, wherein the silicone binder is the cured product of a 2-part hydrosilylation curable silicone rubber composition designed to adhere to the textile support layer (i) and the skin layer (iii), which has a shore A hardness of from 20 to 40 measured in accordance with ASTM D2240;
(iii) A silicone skin layer, wherein the silicone skin layer is the cured product of a 2-part hydrosilylation curable silicone rubber composition comprising an adhesion promoter, which silicone skin layer has a shore A hardness greater than or equal to (≥) 50 when measured in accordance with ASTM D2240;
(iv) a silicone topcoat layer wherein the silicone topcoat layer is the cured product of a 2-part hydrosilylation curable silicone topcoat which comprises an adhesion promoter; and
(v) a silicone/polyurethane hybrid prepolymer based coating layer produced by curing the carbinol terminated silicone/polyurethane hybrid prepolymer based coating composition.

In the silicone leather composite material, a silicone binder (ii) is adhered between textile support (i) and the skin layer (iii), the skin layer (iii) is between the silicone binder layer (ii) and the silicone/polyurethane hybrid prepolymer based coating layer and silicone topcoat layer (iv) is on the silicone/polyurethane hybrid prepolymer based coating layer (v). Hence the silicone/polyurethane hybrid prepolymer based coating layer (v) is between skin layer (iii) and silicone topcoat layer (iv).

In the silicone leather composite material in addition to the carbinol terminated silicone/polyurethane hybrid prepolymer based coating layer which is the cured product of the carbinol terminated silicone/polyurethane hybrid prepolymer based coating composition (v) described above, there is provided:

The Silicone Leather Composite Material Textile Support Layer (i)

The textile support layer (i) may be made from any suitable textile material for example woven, knitted or non-woven textiles made from natural fibers such as cellulose fibers such as cotton; hemp, silk and wool and/or synthetic fibers, and/or, microfibers. The synthetic fibers, and/or, microfibers may include but are not restricted to polyester, viscose rayon, polyamide fiber such as nylon, polyurethane, acrylic, polyolefin, e.g., polyethylene; and elastic textile materials, such as spandex, acetate, polylactic acid, glass fibres and carbon fibers, may be used as may mixtures of any two or more of the above. The textile support layer (i) is designed to enhance mechanical strength of the silicone leather composite material.

The Silicone Leather Composite Material Silicone Binder Layer (ii) Silicone binder layer (ii) is the cured product of a suitable 2-part hydrosilylation curable silicone rubber composition designed to adhere to the textile support layer (i) and the skin layer (iii). The silicone binder layer (ii) selected has a relatively low shore A hardness of from 20 to 40 measured in accordance with ASTM D2240. The silicone binder layer (ii) may be of any desired average dry coat thickness, for example 50 μm to 1 mm thick, alternatively 50 to 750 μm, alternatively 50 to 500 μm, alternatively 100 to 500 μm, alternatively 100 to 300 μm thick. In one preferable embodiment silicone binder layer (ii) has a high elongation at break e.g., an elongation at break of at least 600% determined in accordance with ASTM D412, alternatively an elongation at break of at least 750% determined in accordance with ASTM D412. It can be cured at any suitable temperature, for example at from 100 to 200 °C, alternatively 125 to 180 °C, alternatively 130 to 170 °C, alternatively 135 to 160 °C for a suitable period of up to 20 minutes, alternatively 1 to 10 minutes, alternatively for a period of from 1.5 minutes to 5 minutes, alternatively 1.5 minutes to 4 minutes.

A commercial example of a suitable hydrosilylation curable liquid silicone rubber composition designed to function as the binder layer is Dowsil™ LCF 8400 Binder, from Dow Silicones Corporation. Dowsil™ LCF 8400 Binder is provided to the customer in a two-part to avoid premature cure with the two-parts of Dowsil™ LCF 8400 Binder being mixed together in a 1:1 ratio prior to use. SILASTIC LCF 8400 Binder is applied onto fabric and cured at a temperature between 100 to 200 °C for a period of from 1-10 minutes to cure). Another commercial example of such an adhesive or binding layer is SILASTIC™ LX-2401 LSR which is commercially available from Dow Silicones Corporation. As previously indicated silicone binder (ii) is designed to be sandwiched between and to adhere to both textile support layer (i) and to skin coating layer (iii).

The Silicone Leather Composite Material Silicone Skin Layer (iii)

The silicone skin layer (iii) is the cured product of a 2-part hydrosilylation curable silicone rubber composition comprising an adhesion promoter, which silicone skin layer has a shore A hardness of greater than or equal to (≥) 50 when measured in accordance with ASTM D2240. In one preferred embodiment silicone skin layer (iii) has an elongation at break of less than 500%, alternatively from 200 to 400% determined in accordance with ASTM D412. The silicone skin layer (iii) is designed to form a protective synthetic leather which is usually adhered to the silicone binder (ii) and otherwise is usually used either alone (i.e., without a topcoat) or is sandwiched between silicone binder (ii) and a suitable topcoat; however, as disclosed herein it is sandwiched between silicone binder (ii) and the carbinol terminated silicone/polyurethane hybrid prepolymer based coating layer (v). Any suitable 2-part hydrosilylation curable silicone rubber composition comprising an adhesion promoter, may be utilised to form silicone skin layer (iii), providing it meets the requirements above. The silicone skin layer (iii) has a larger Shore A durometer than silicone binder (ii) of greater than or equal to (≥) 50, when measured in accordance with ASTM D2240; alternatively of from 50 to 90, alternatively or from 60 to 90.

The silicone skin layer (iii) also comprises an adhesion promoter. For example, the adhesion promoter may comprise one or more acryloxysilanes, isocyanatoalkylsilanes, methacrylates and/or alkoxysilanes having an epoxy group in the molecules.

The acryloxysilanes may include 3-acryloxypropyl-trimethoxysilane, 3-acryloxypropyl-methyldimethoxysilane, 3-acryloxypropyl-dimethyl-methoxysilane, 3-acryloxypropyl-triethoxysilane, or a similar acryloxy-substituted alkyl-containing alkoxysilane.

The isocyanatoalkylsilanes, must comprise at least one isocyanatoalkyl group per molecule e.g., an isocyanatopropyl group and may for example be an (isocyanatoalkyl)trialkoxysilane or an (isocyanatopropyl)dialkoxy(alkyl)silane wherein in each case, each alkyl group contains from 1 to 6 carbons, alternatively 1 to 4 carbons and each alkoxy group contains from 1 to 6 carbons, alternatively from 2 to 4 carbons. Specific examples include (3-isocyanatopropyl)trimethoxysilane, (3-isocyanatopropyl)trimethoxysilane, (3-isocyanatopropyl)dimethoxy(methyl)silane, (3-isocyanatopropyl)diethoxy(methyl)silane (3-isocyanatopropyl)dimethoxy(ethyl)silane and (3-isocyanatopropyl)diethoxy(ethyl)silane.

The methacrylates may comprise alkoxysilanes containing methacrylic groups such as methacryloxymethyl-trimethoxysilane, 3-methacryloxypropyl-trimethoxysilane, 3-methacryloxypropyl-methyldimethoxysilane, 3-methacryloxypropyl-dimethylmethoxysilane, 3-methacryloxypropyl-triethoxysilane, 3-methacryloxypropyl-methyldiethoxysilane, 3-methacryloxyisobutyl-trimethoxysilane, or a similar methacryloxy-substituted alkoxysilane.

Examples of alkoxysilanes having an epoxy group in the molecule which may be used as adhesion promoter may have the formula:

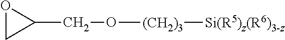

wherein each R⁵ is the same or different and is an alkyl group having 1 to 6 carbons, each R⁶ is the same or different and is an alkoxy group having 1 to 6 carbons and z=0, 1 or 2, or a mixture thereof, in an amount of from 1 to 6 wt. % of the composition. Alternatively, each R⁵ is an alkyl group having 1 to 3 carbons, alternatively having 1 to 2 carbons. Alternatively, each R⁶ is an alkoxy group having 1 to 3 carbons, alternatively having 1 to 2 carbons. Preferably z is 0 or 1, alternatively z is 0. Specific examples include 3-glycidoxypropyl trimethoxysilane, 3-glycidoxypropyl triethoxysilane, 3-glycidoxypropyl methyldimethoxysilane, 3-glycidoxypropylmethyldiethoxysilane, 4-glycidoxybutyl trimethoxysilane, 5,6-epoxyhexyl triethoxysilane, 2-(3,4-epoxycyclohexyl) ethyltrimethoxysilane, or 2-(3,4-epoxycyclohexyl) ethyltriethoxysilane.

The adhesion promoter may alternatively comprise a mixture and/or reaction product of
i) one or more alkoxysilanes having an epoxy group in the molecule as defined above;
(ii) an organometallic condensation reaction catalyst comprising organoaluminum or organozirconium compounds; and optionally
(iii) a linear organopolysiloxane oligomer containing at least one alkenyl group and at least one hydroxy or alkoxy group per molecule.

The organometallic condensation reaction catalyst (ii) comprising organoaluminum or organozirconium compounds may be selected from organometallic catalysts comprising zirconates, organoaluminium chelates, and/or zirconium chelates.

Zirconate based catalysts may comprise a compound according to the general formula or Zr[OR⁵]₄ where each R⁵ may be the same or different and represents a monovalent, primary, secondary or tertiary aliphatic hydrocarbon group which may be linear or branched containing from 1 to 20 carbon atoms, alternatively 1 to 10 carbon atoms. Optionally the zirconate may contain partially unsaturated groups. Preferred examples of R⁵ include but are not restricted to methyl, ethyl, propyl, isopropyl, butyl, tertiary butyl and a branched secondary alkyl group such as 2,4-dimethyl-3-pentyl. Preferably, when each R⁵ is the same, R⁵ is an isopropyl, branched secondary alkyl group or a tertiary alkyl group, in particular, tertiary butyl. Specific examples include, zirconium tetrapropylate and zirconium tetrabutyrate, tetra-isopropyl zirconate, zirconium (IV) tetraacetyl acetonate, (sometimes referred to as zirconium AcAc₄, zirconium (IV) hexafluoracetyl acetonate, zirconium (IV) trifluoroacetyl acetonate, tetrakis (ethyltrifluoroacetyl acetonate) zirconium, tetrakis (2,2,6,6-tetramethyl-heptanethionate) zirconium, zirconium (IV) dibutoxy bis(ethylacetonate), zirconium tributoxyacetylacetate, zirconium butoxyacetylacetonate bisethylacetoacetate, zirconium butoxyacetylacetonate bisethylacetoacetate, diisopropoxy bis(2,2,6,6-tetramethyl-heptanethionate) zirconium, or similar zirconium complexes having β-diketones (including alkyl-substituted and fluoro-substituted forms thereof) which are used as ligands.

Suitable aluminium-based condensation catalysts may include but are not limited to one or more of Al(OC₃H₇)₃, Al(OC₃H₇)₂(C₃COCH₂COCl₂H₂₅), Al(OC₃H₇)₂(OCOCH₃), and Al(OC₃H₇)₂(OCOC₁₂H₂₅).

Organometallic condensation reaction catalyst (ii) may be present in the composition in an amount of from 0.1 to 5% by weight of the composition, alternatively 0.1 to 3% by weight, alternatively 0.1 to 2% by weight of the composition. When adhesion promoter is comprises a cumulative amount of (i), (ii) and (iii), it may comprise from about 0.3 to 6 wt. % of the composition; alternatively, 0.3 to 4 wt. % of the composition.

The linear organopolysiloxane oligomer (iii) containing at least one alkenyl group and at least one hydroxy or alkoxy group per molecule can for example be a methylvinylpolysiloxane in which both molecular terminals are dimethylhydroxysiloxy units, or a copolymer of a methylvinyl siloxane and dimethylsiloxane units in which both molecular terminals are dimethylhydroxysiloxy units.

The organopolysiloxane oligomer (iii) can be a mixture of organopolysiloxane molecules, some of which have silanol end groups at both molecular terminals and some of which have only one silanol group such as a dimethylhydroxysiloxy terminal unit with the other terminal unit being for example a dimethylmethoxysiloxy unit, a trimethylsiloxy unit or a dimethylvinylsiloxy unit. Preferably more than 50% by weight of the organopolysiloxane oligomer (iii), more preferably 60-100% comprises molecules having silanol end groups at both molecular terminals.

The organopolysiloxane oligomer (iii) preferably contains at least 3%, more preferably at least 5%, by weight vinyl groups, and can contain up to 35 or 40% by weight vinyl groups. Most preferably the organopolysiloxane oligomer (iii) contains 5 to 30% by weight vinyl groups. The organopolysiloxane oligomer (iii) preferably has a number average molecular weight of 100 to 10,000 g/mol as measured using gel permeation chromatography using test GB/T 21863-2008. The organopolysiloxane oligomer (iii) preferably has a viscosity of from 0.1 to 300 mPa·s, alternatively a viscosity of 0.1 to 200 mPa·s, alternatively from 1 to 100 mPa·s. (measured using a Brookfield DV 3T Rheometer at 25 °C). The organopolysiloxane oligomer (iii) may be present in the composition in an amount of from 0.1 to 5% by weight of the composition, alternatively 0.1 to 3% by weight, alternatively 0.1 to 2% by weight of the composition.

The silicone skin layer (iii) may be of any suitable average dry coat thickness, for example, the binder layer may be of any desired thickness, for example 50 m to 1 mm, thick, 50 to 750 μm, alternatively 50 to 500 m, alternatively 50 to 350 μm, alternatively 50 to 250 μm thick. It can be cured at any suitable temperature, for example at 100 to 150 °C, alternatively 110 to 135 °C, alternatively 110 to 125 °C for a period of from 30 seconds to 5 minutes, alternatively 30 seconds to 2.5 minutes.

Excepting the need to introduce a suitable adhesion promoter as described above, commercial examples of suitable liquid silicone rubber compositions curable to function as skin layer (iii) are Dowsil™ LCF 8300 Skin and Dowsil™ LCF 8500 Skin both from Dow Silicones Corporation, which given they are both hydrosilylation curable liquid silicone rubber compositions are again provided to the user in two-parts which are mixed together prior to use to avoid premature cure in storage prior to use.

Dowsil™ LCF 8300 Skin and Dowsil™ LCF 8500 Skin both have a high shore A durometer value of between 65-70 with Dowsil™ LCF 8300 Skin having, compared to Dowsil™ LCF 8500 Skin, a relatively low viscosity. Dowsil™ LCF 8500 Skin is much higher viscosity as it is a fumed silica reinforced version of the former having high mechanical strength. Hence, if or when desired a mixture of Dowsil™ LCF 8300 Skin and Dowsil™ LCF 8500 Skin may be utilised as silicone skin layer (iii). Another suitable commercial material which may be utilised as the skin layer (iii) is SILASTIC™ LX-2351 LSR also available commercially from Dow Silicones Corporation.

### The Silicone Leather Composite Material Silicone Topcoat Layer (iv)

Any 2-part hydrosilylation curable silicone topcoat composition may be utilised to prepare the silicone topcoat layer (iv) for the silicone leather composite material described herein. The 2-part hydrosilylation curable silicone topcoat composition must comprise an adhesion promoter for example one of the adhesion promoters identified as suitable for silicone skin layer (iii) above.

An example of a suitable silicone topcoat (iv) may be the cured product of a composition comprising
Component (iv)(a), one or more organopolysiloxane polymer(s) having at least two unsaturated groups per molecule which unsaturated groups are selected from alkenyl groups, alkynyl groups or a mixture thereof; having a viscosity of from 100 to 500,000 mPa·s at 25 °C.;
Component (iv)(b) a silica reinforcing filler which is optionally hydrophobically treated;
Component (iv)(c) a polyorganosiloxane containing at least two or alternatively at least three silicon bonded hydrogen (—Si—H) groups per molecule;
Component (iv)(d) a hydrosilylation catalyst;
Component (iv)(e) an adhesion promoter as described above with respect to silicone skin layer (iii) or a combination of zirconium acetylacetonate in an amount of from 1 to 5 wt. % of the composition with 1,3,5-tris[3-(trimethoxysilyl)propyl]-1,3,5-triazine-2,4,6(1H,3H,5H)-trione, and/or one or more epoxy silanes of the formula

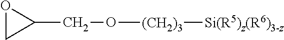

wherein R⁵ is an alkyl group having 1 to 6 carbons, R⁶ is an alkoxy group having 1 to 6 carbons and z=0, 1 or 2, or a mixture thereof, in an amount of from 1 to 6 wt. % of the composition; and
Component (iv)(f) an eco-solvent; and optionally
Component (iv)(g) a cured silicone powder.

In such a composition:

(iv)(a) Organopolysiloxane Polymer(s)

Component (iv)(a) of the 2-part hydrosilylation curable silicone topcoat composition is one or more organopolysiloxane polymer(s) having at least two unsaturated groups per molecule, which unsaturated groups are selected from alkenyl groups, alkynyl groups or a mixture thereof; having a viscosity of from 100 to 500,000 mPa·s at 25 °C.

Organopolysiloxane polymer (iv)(a) has multiple groups of the formula (I):

RₐSiO_{(4-a)/2} (I)

in which, providing it comprises the prerequisite number of unsaturated groups, each R is independently selected from an aliphatic hydrocarbyl, aromatic hydrocarbyl, or organyl group (that is any organic substituent group, regardless of functional type, having one free valence at a carbon atom). The groups may be in pendent positions (on a D or T siloxy group) or may be terminal (on an M siloxy group). Saturated aliphatic hydrocarbyls are exemplified by, but not limited to, monovalent saturated hydrocarbon groups, i.e., alkyl groups which typically contain from 1 to 20 carbon atoms, such as methyl, ethyl, propyl, pentyl, octyl, undecyl, and octadecyl and cycloalkyl groups such as cyclohexyl. Unsaturated aliphatic hydrocarbyls are exemplified by alkenyl groups having from 2 to 10 carbon atoms, such as vinyl, allyl, butenyl, pentenyl, isopropenyl, 5-hexenyl, cyclohexenyl and hexenyl; and by alkynyl groups. Aromatic hydrocarbon groups are exemplified by, but not limited to, phenyl, tolyl, xylyl, benzyl, styryl, and 2-phenylethyl. Organyl groups are exemplified by, but not limited to, halogenated alkyl groups such as chloromethyl and 3-chloropropyl; nitrogen containing groups such as amino groups, amido groups, imino groups, imido groups; oxygen containing groups such as polyoxyalkylene groups, carbonyl groups, alkoxy groups and hydroxyl groups. Further organyl groups may include sulfur containing groups, phosphorus containing groups and/or boron containing groups. The subscript “a” may be 0, 1, 2 or 3, but is typically mainly 2 or 3. Siloxy groups may be described by a shorthand (abbreviated) nomenclature, namely—“M,” “D,” “T,” and “Q”, when R is an organic group, typically a methyl group. The M group corresponds to a siloxy group where a=3, that is R₃SiO_{1/2}; the D group corresponds to a siloxy group where a=2, namely R₂SiO_{2/2}; the T group corresponds to a siloxy group where a=1, namely R₁SiO_{3/2}; the Q group corresponds to a siloxy group where a=0, namely SiO_{4/2}.

The molecular structure of organopolysiloxane polymer (iv)(a) is typically linear, however, there can be some branching due to the presence of T groups (as previously described) within the molecule. To achieve a useful level of physical properties in the silicone topcoat layer prepared by curing the 2-part hydrosilylation curable silicone topcoat composition as hereinbefore described, the viscosity of organopolysiloxane polymer (iv)(a) should be at least 100 mPa·s at 25 °C. The upper limit for the viscosity of organopolysiloxane polymer (iv)(a) is limited to a viscosity of up to 500,000 mPa·s at 25 °C.

The amount (wt. %) of unsaturated groups present is determined using quantitative infra-red analysis in accordance with ASTM E168. Component (iv)(a) has a viscosity of from 100 mPa·s to 500,000 mPa·s at 25 °C, alternatively 200 mPa·s to 150,000 mPa·s at 25 °C, alternatively from 200 mPa·s to 125,000 mPa·s at 25 °C, alternatively from 200 mPa·s to 100,000 mPa·s at 25 °C alternatively from 200 mPa·s to 80,000 mPa·s measured at 25 °C. Viscosities can be measured using either a Brookfield™ rotational viscometer with spindle CPA-52Z for viscosities in the range between 10,000-400,000 mPa·s. Other viscosities were measured using a Brookfield™ rotational viscometer with spindle LV-62 for viscosities in the range between 15-10,000 mPa·s and a rotation speed of 10 rpm unless otherwise indicated or a Brookfield™ rotational viscometer with spindle LV-4 (designed for viscosities in the range between 1,000-2,000,000 mPa·s) or a Brookfield™ rotational viscometer with spindle LV-1 (designed for viscosities in the range between 15-20,000 mPa·s) for viscosities less than 1000 mPa·s and a suitable rotation speed. The organopolysiloxane polymer (iv)(a) may be selected from polydimethylsiloxanes, alkylmethylpolysiloxanes, alkylarylpolysiloxanes or copolymers thereof containing e.g., alkenyl and/or alkynyl groups and may have any suitable terminal groups, for example, they may be trialkyl terminated, alkenyldialkyl terminated or may be terminated with any other suitable terminal group combination providing each organopolysiloxane polymer (iv)(a) contains at least two unsaturated groups per molecule.

Hence the organopolysiloxane polymer (iv)(a) may be, for the sake of example, dimethylvinyl terminated polydimethylsiloxane, dimethylvinyl terminated dimethylmethylphenylsiloxane, trialkyl terminated dimethylmethylvinyl polysiloxane or dialkylvinyl terminated dimethylmethylvinyl polysiloxane copolymers, although given the high level of alkenyl and/or alkynyl groups present such as vinyl groups trialkyl terminated dimethylmethylvinyl polysiloxane or dialkylvinyl terminated dimethylmethylvinyl polysiloxane copolymers may be preferred.

For example, an organopolysiloxane polymer (iv)(a) containing unsaturated groups selected from alkenyl groups and/or alkynyl groups at the two terminals may be represented by the general formula (II):

R′R″R′″SiO—(R″R′″SiO)ₘ—SiOR′″R″R′ (II)

In formula (II), each R′ may be an alkenyl group or an alkynyl group, which typically contains from 2 to 10 carbon atoms. Alkenyl groups include but are not limited to vinyl, propenyl, butenyl, pentenyl, hexenyl an alkenylated cyclohexyl group, heptenyl, octenyl, nonenyl, decenyl or similar linear and branched alkenyl groups and alkenylated aromatic ringed structures. Alkynyl groups may be selected from but are not limited to ethynyl, propynyl, butynyl, pentynyl, hexynyl, an alkynylated cyclohexyl group, heptynyl, octynyl, nonynyl, decynyl or similar linear and branched alkenyl groups and alkenylated aromatic ringed structures.

R″ does not contain ethylenic unsaturation, each R″ may be the same or different and is individually selected from monovalent saturated hydrocarbon group, which typically contain from 1 to 10 carbon atoms, and monovalent aromatic hydrocarbon group, which typically contain from 6 to 12 carbon atoms. R″ may be unsubstituted or substituted with one or more groups that do not interfere with curing of the 2-part hydrosilylation curable silicone topcoat composition described herein, such as halogen atoms. R″ is R′ or R″ and m is a whole number.

Component (iv)(a) of the 2-part hydrosilylation curable silicone topcoat composition may comprise more than one organopolysiloxane polymer (iv)(a), having a viscosity of from 100 to 500,000 mPa·s at 25 °C. When a mixture of organopolysiloxane polymers is used for component (iv)(a), at least one, alternatively one may comprise at least 5 wt. % of the polymer per molecule of unsaturated groups selected from alkenyl groups, alkynyl groups or a mixture thereof, alternatively from 5 to 15 wt. % of the polymer per molecule, alternatively from 6 to 15 wt. % of the polymer per molecule, alternatively from 7 to 15 wt. % of the polymer per molecule which may be determined using quantitative infra-red analysis in accordance with ASTM E168.

Component (iv)(a) is typically present in an amount of from 3 wt. %, alternatively from 10 wt. % of the 2-part hydrosilylation curable silicone topcoat composition, to 50 wt. %, alternatively 45 wt. % of the composition, for example organopolysiloxane polymer (iv)(a) may be present in a range of from 10 to 50 wt. %, alternatively from 10 to 45 wt. % of the composition.

(iv)(b) Reinforcing Filler

Component (iv)(b) of the 2-part hydrosilylation curable silicone topcoat composition is a reinforcing filler such as a reinforcing silica. Silica and other reinforcing fillers (iv)(b) are often treated with one or more known hydrophobing filler treating agents to prevent a phenomenon referred to as “creping” or “crepe hardening” during processing of the 2-part hydrosilylation curable silicone topcoat composition.

Finely divided forms of silica are preferred as reinforcing fillers (iv)(b). Precipitated and/or fumed silicas, alternatively fumed silica is/are particularly preferred because of their relatively high surface area, which is typically at least 50 m²/g (BET method in accordance with ISO 9277: 2010). Fillers having surface areas of from 50 to 450 m²/g (BET method in accordance with ISO 9277: 2010), alternatively of from 50 to 300 m²/g (BET method in accordance with ISO 9277: 2010), are typically used. Both types of silica are commercially available.

The amount of reinforcing filler (iv)(b) in the 2-part hydrosilylation curable silicone topcoat composition herein is from 5 to 40 wt. %, alternatively of from 5 to 30 wt. %. In some instances, the amount of reinforcing filler may be of from 7.5 to 30 wt. %., alternatively from 10 to 30 wt. %. based on the weight of the 2-part hydrosilylation curable silicone topcoat composition, alternatively from 15 to 30 wt. %. based on the weight of the composition.

When reinforcing filler (iv)(b) is naturally hydrophilic (e.g., untreated silica fillers), it is typically treated with a treating agent to render it hydrophobic. These surface modified reinforcing fillers (iv)(b) do not clump and can be homogeneously incorporated into organopolysiloxane polymer (iv)(a) as the surface treatment makes the fillers easily wetted by organopolysiloxane polymer (iv)(a). This results in improved room temperature mechanical properties of the 2-part hydrosilylation curable silicone topcoat compositions and resulting cured materials cured therefrom.

The surface treatment may be undertaken prior to introduction in the composition or in situ (i.e., in the presence of at least a portion of the other components of the composition herein by blending these components together at room temperature or above until the filler is completely treated.

Typically, untreated reinforcing filler (iv)(b) is treated in situ with a treating agent in the presence of organopolysiloxane polymer (iv)(a), whereafter mixing a silicone rubber base material is obtained, to which other components may be added.

Typically reinforcing filler (ii) may be surface treated with any low molecular weight organosilicon compounds disclosed in the art applicable to prevent creping of the 2-part hydrosilylation curable silicone topcoat composition during processing. For example, organosilanes, organopolysiloxanes, or organosilazanes e.g., hexaalkyl disilazane, short chain siloxane diols or fatty acids or fatty acid esters such as stearates to render the filler(s) hydrophobic and therefore easier to handle and obtain a homogeneous mixture with the other components. Specific examples include, but are not restricted to, silanol terminated trifluoropropylmethyl siloxane, dimethyl silanol terminated vinylmethyl (ViMe) siloxane, tetramethyldi(trifluoropropyl)disilazane, tetramethyldivinyl disilazane, silanol terminated MePh siloxane, liquid hydroxyl-terminated polydiorganosiloxane containing an average from 2 to 20 repeating groups of diorganosiloxane in each molecule, hexaorganodisiloxane, hexaorganodisilazane. A small amount of water can be added together with the silica treating agent(s) as processing aid.

The filler may be introduced into the 2-part hydrosilylation curable silicone topcoat composition in the form of a masterbatch or base comprising said filler and an organopolysiloxane polymer. The organopolysiloxane polymer used for the masterbatch or base may be of a similar structure to component (iv)(a) but alternatively may be an organopolysiloxane polymer having a viscosity in the same range as component (iv)(a) but having an alkenyl and/or alkynyl content of <5 wt. % of the polymer. If required, the fumed silica may be hydrophobically treated in situ during the preparation of the masterbatch by the introduction of suitable hydrophobing agents into the mixture. The 2-part hydrosilylation curable silicone topcoat composition as described herein is cured using a hydrosilylation cure package comprising an organohydrogenpolysiloxane having 2 or more, alternatively 3 or mor silicon-bonded hydrogen atoms per molecule (iv)(c) and a hydrosilylation catalyst (iv)(d).

(iv)(c) Organohydrogenpolysiloxane

Component (iv)(c) is a cross-linker in the form of a polyorganosiloxane containing at least two or alternatively at least three silicon bonded hydrogen (—Si—H) groups per molecule.

Component (iv)(c) normally contains three or more —Si—H groups so that the hydrogen atoms can react with the unsaturated alkenyl or alkynyl groups of component (iv)(a) to form a network structure therewith and thereby cure the composition. Some or all of Component (iv)(c) may alternatively have two —Si—H groups per molecule particularly when component (iv)(a) has greater than (>) two alkenyl or alkynyl groups per molecule.

The molecular configuration of the polyorganosiloxane containing at least two or three Si—H groups per molecule (iv)(c) is not specifically restricted, and it can be a straight chain, a straight chain with some branching, cyclic or silicone resin based.

Silicon-bonded organic groups used in component (iv)(c) may be exemplified by methyl, ethyl, propyl, butenyl, pentenyl, hexyl, or similar alkyl groups; phenyl, tolyl, xylyl, or similar aryl groups; 3-chloropropyl, 3,3,3-trifluoropropyl, or similar halogenated alkyl group, preferable of which are methyl and phenyl groups.

Examples of the polyorganosiloxane containing at least two or three silicon bonded hydrogen groups per molecule (iv)(c) include but are not limited to:
(a) branched and/or chain extended dimethylhydrogensiloxy-terminated polydimethylsiloxanes,
(b) dimethylhydrogensiloxy-terminated dimethylsiloxane-methylhydrogensiloxane copolymers,
(c) copolymers and/or silicon resins consisting of (CH₃)₂HSiO_{1/2} units, (CH₃)₃SiO_{1/2} units and SiO_{4/2} units,
(d) copolymers and/or silicone resins consisting of (CH₃)₂HSiO_{1/2} units and SiO_{4/2} units,
(e) copolymers and/or silicone resins consisting of (CH₃)₂HSiO_{1/2} units, SiO_{4/2} units and (C₆H₅)₃SiO_{1/2} units, and alternatives in which methyl is replaced by phenyl groups or other alkyl groups.
(f) silicone resins comprising or consisting of Si—H groups such as (CH₃)₂HSiO_{1/2} groups, (CH₃)₂SiO_{2/2} groups and SiO_{4/2} groups.

The silicone resins mentioned above may also comprise T groups and/or D groups, alternatively T groups. Other potential cross-linkers (iv)(c) may include
(g) 1,1,3,3-tetramethyldisiloxane,
(h) 1,3,5,7-tetramethylcyclotetrasiloxane,
(i) tris(hydrogendimethylsiloxy)methylsilane,
(j) tris(hydrogendimethylsiloxy)phenylsilane, methylhydrogencyclopolysiloxane,
(k) trimethylsiloxy-end-blocked methylhydrogenpolysiloxane,
(l) trimethylsiloxy-end-blocked dimethylsiloxane/methylhydrogensiloxane copolymers,
(m) dimethylhydrogensiloxy-end-blocked dimethylpolysiloxane,
(n) dimethylhydrogensiloxy-end-blocked dimethylsiloxane/methylhydrogensiloxane copolymers,
(o) trimethylsiloxy-end-blocked methylhydrogensiloxane/diphenylsiloxane copolymers,
(p) trimethylsiloxy-end-blocked methylhydrogensiloxane/diphenylsiloxane/-dimethylsiloxane copolymers,
(q) trimethylsiloxy-end-blocked methylhydrogensiloxane/methylphenylsiloxane/-dimethylsiloxane copolymers,
(r) dimethylhydrogensiloxy-end-blocked/dimethylsiloxane/-diphenylsiloxane copolymers and/or
(s) dimethylhydrogensiloxy-end-blocked methylhydrogensiloxane/dimethylsiloxane/-methylphenylsiloxane copolymers,
(t) Others include tetrakis(dimethylsiloxy)silane, hydride terminated, polyphenylmethyl siloxane hydride terminated, polyphenyl-(dimethylhydrosiloxy) siloxane, or phenyltris(dimethylsiloxy)silane or the like. Alternatively, component (iv)(c), the cross-linker, may be a filler, e.g., silica treated with one of the above.

In one alternative the cross-linker (iv)(c) may be a silicone resin comprising a mixture of Q, T, D and/or M groups having a viscosity of from 10 to 5000 mPa·s at 25 °C, alternatively 10 to 1000 mPa·s at 25 °C, alternatively 10 to 500 mPa·s at 25 °C such as alternatives (c), (d) and/or (e) as described above.

The polyorganosiloxane containing at least two or three —Si—H groups per molecule (iv)(c) is typically added in an amount such that the molar ratio of the silicon-bonded hydrogen atoms in component (iv)(c) to that of all unsaturated groups in the composition is from 0.5:1 to 20:1; alternatively of from 0.5:1 to 5:1, alternatively from 0.6:1 to 3:1. When this molar ratio is less than 0.5:1, a well-cured composition will not be obtained. When the molar ratio exceeds 20:1, there is a tendency for the hardness of the cured composition to increase when heated.

The silicon-bonded hydrogen (Si—H) content of component (iv)(c) is determined using quantitative infra-red analysis in accordance with ASTM E168. In the present instance the silicon-bonded hydrogen to alkenyl (vinyl) and/or alkynyl molar ratio is important when relying on a hydrosilylation cure process. Generally, this is determined by calculating the total weight % of alkenyl groups in the composition, e.g., vinyl [V] and the total weight % of silicon bonded hydrogen [H] in the 2-part hydrosilylation curable silicone topcoat composition and given the molecular weight of hydrogen is 1 and of vinyl is 27 the molar ratio of silicon bonded hydrogen to vinyl is 27[H]/[V].

While the molecular weight of this component is not specifically restricted, the viscosity is typically from 15 to 50,000 mPa·s at 25 °C. relying on a Brookfield DV 3T Rheometer or using either a Brookfield™ rotational viscometer with spindle CPA-52Z for viscosities in the range between 10,000-400,000 mPa·s. Other viscosities were measured using a Brookfield™ rotational viscometer with spindle LV-62 for viscosities in the range between 15-10,000 mPa·s and a rotation speed of 10 rpm unless otherwise indicated or a Brookfield™ rotational viscometer with spindle LV-4 (designed for viscosities in the range between 1,000-2,000,000 mPa·s) or a Brookfield™ rotational viscometer with spindle LV-1 (designed for viscosities in the range between 15-20,000 mPa·s) for viscosities less than 1000 mPa·s and a rotation speed of 10 rpm.

Component (iv)(c) of the 2-part hydrosilylation curable silicone topcoat composition is a polyorganosiloxane containing at least two or alternatively at least three silicon bonded hydrogen (—Si—H) groups per molecule, which functions as a cross-linker for polymer (iv)(a), by the addition reaction of the silicon-bonded hydrogen atoms in component (iv)(c) with the alkenyl groups and/or alkynyl groups in component (iv)(a) under the catalytic activity of component (iv)(d) to be mentioned below. Component (iv)(c) contains at least 5,000 parts per million (ppm) of silicon bonded hydrogen (Si—H), alternatively at least 7000 ppm, alternatively from 7000 to 12,000 ppm of silicon bonded hydrogen, alternatively 8000 ppm to 11,000 ppm of silicon bonded hydrogen so that the silicon bonded hydrogen atoms of this component can sufficiently react with the alkenyl groups and/or alkynyl groups, typically alkenyl groups, especially vinyl groups of component (iv)(a) to form a network structure therewith and thereby cure the composition. The quantity of silicon bonded hydrogen present is also determined using quantitative infra-red analysis in accordance with ASTM E168.

Component (iv)(c) is typically present in the total 2-part hydrosilylation curable silicone topcoat composition in an amount of from 5 to 30 wt. %, 5 to 20 wt. %, alternatively from 10 to 20 wt. % of the composition but the amount present is typically determined by the molar ratio of the silicon-bonded hydrogen atoms in component (iv)(c) to the total number of all unsaturated groups, e.g., alkenyl and alkynyl groups, often vinyl groups as described above.

(iv)(d) Hydrosilylation Catalyst

The 2-part hydrosilylation curable silicone topcoat composition is cured via a hydrosilylation (addition) reaction catalysed by a hydrosilylation (addition cure) catalyst (iv)(d) that is a metal selected from the platinum group metals, i.e., platinum, ruthenium, osmium, rhodium, iridium and palladium, or a compound of such metals. Platinum and rhodium compounds are preferred due to the high activity level of these catalysts for hydrosilylation reactions.

The hydrosilylation catalyst (iv)(d) can be a platinum group metal, a platinum group metal deposited on a carrier, such as activated carbon, metal oxides, such as aluminum oxide or silicon dioxide, silica gel or powdered charcoal, or a compound or complex of a platinum group metal. Preferably the platinum group metal is platinum.

Examples of preferred hydrosilylation catalysts (iv)(d) are platinum based catalysts, for example, platinum black, platinum oxide (Adams catalyst), platinum on various solid supports, chloroplatinic acids, e.g., hexachloroplatinic acid (Pt oxidation state IV) (Speier catalyst), chloroplatinic acid in solutions of alcohols e.g., isooctanol or amyl alcohol (Lamoreaux catalyst), and complexes of chloroplatinic acid with ethylenically unsaturated compounds such as olefins and organosiloxanes containing ethylenically unsaturated silicon-bonded hydrocarbon groups, e.g., tetra-vinyl-tetramethylcyclotetrasiloxane-platinum complex (Ashby catalyst). Soluble platinum compounds that can be used include, for example, the platinum-olefin complexes of the formulae (PtCl₂·(olefin)₂ and H(PtCl₃·olefin), preference being given in this context to the use of alkenes having 2 to 8 carbon atoms, such as ethylene, propylene, isomers of butene and of octene, or cycloalkanes having 5 to 7 carbon atoms, such as cyclopentene, cyclohexene, and cycloheptene. Other soluble platinum catalysts are, for the sake of example a platinum-cyclopropane complex of the formula (PtCl₂C₃H₆)₂, the reaction products of hexachloroplatinic acid with alcohols, ethers, and aldehydes or mixtures thereof, or the reaction product of hexachloroplatinic acid and/or its conversion products with vinyl-containing siloxanes such as methylvinylcyclotetrasiloxane in the presence of sodium bicarbonate in ethanolic solution -. Platinum catalysts with phosphorus, sulfur, and amine ligands can be used as well, e.g., (Ph₃P)₂PtCl₂; and complexes of platinum with vinylsiloxanes, such as sym-divinyltetramethyldisiloxane.

Hence, specific examples of suitable platinum-based catalysts of (iv)(d) include:—
(i) complexes of chloroplatinic acid with organosiloxanes containing ethylenically unsaturated hydrocarbon groups are described in U.S. Pat. No. 3,419,593;
(ii) chloroplatinic acid, either in hexahydrate form or anhydrous form;
(iii) a platinum-containing catalyst which is obtained by a method comprising reacting chloroplatinic acid with an aliphatically unsaturated organosilicon compound, such as divinyltetramethyldisiloxane;
(iv) alkene-platinum-silyl complexes as described in U.S. Pat. No. 6,605,734 such as (COD)Pt(SiMeCl₂)₂ where “COD” is 1,5-cyclooctadiene; and/or
(v) Karstedt's catalyst, a platinum divinyl tetramethyl disiloxane complex typically containing about 1 wt. % of platinum typically in a vinyl siloxane polymer. Solvents such as toluene and the like organic solvents have been used historically as alternatives but the use of vinyl siloxane polymers by far the preferred choice. These are described in U.S. Pat. Nos. 3,715,334 and 3,814,730. In one preferred embodiment component (iv)(d) may be selected from co-ordination compounds of platinum. In one embodiment hexachloroplatinic acid and its conversion products with vinyl-containing siloxanes, Karstedt's catalysts and Speier catalysts are preferred.

The catalytic amount of the hydrosilylation catalyst is generally between 0.01 ppm, and 10,000 parts by weight of platinum-group metal, per million parts (ppm), based on the weight of the 2-part hydrosilylation curable silicone topcoat composition; alternatively, between 0.01 and 5000 ppm; alternatively, between 0.01 and 3,000 ppm, and alternatively between 0.01 and 1,000 ppm. In specific embodiments, the catalytic amount of the catalyst may range from 0.01 to 1,000 ppm, alternatively 0.01 to 750 ppm, alternatively 0.01 to 500 ppm and alternatively 0.01 to 100 ppm of metal based on the weight of the 2-part hydrosilylation curable silicone topcoat composition. The ranges may relate solely to the metal content within the catalyst or to the catalyst altogether (including its ligands) as specified, but typically these ranges relate solely to the metal content within the catalyst. The catalyst may be added as a single species or as a mixture of two or more different species. Typically, dependent on the form/concentration in which the catalyst is provided e.g., in a polymer or solvent, the amount of component (iv)(d) present will be within the range of from 0.001 to 3.0 wt. % of the composition, alternatively from 0.001 to 2.5 wt. % of the composition, alternatively 0.01 to 2.0 wt. %, of the 2-part hydrosilylation curable silicone topcoat composition.

Component (iv)(e) Adhesion Promoter

Component (iv)(e) is an adhesion promoter which is used to assist in the adherence of the silicone topcoat (iv) to the carbinol terminated silicone/polyurethane hybrid prepolymer based coating layer (v). Component (iv)(e) may be any of the adhesion promoters identified above. However, one particularly preferred adhesion promoter for use as component (iv)(e) is where the adhesion promoter is a combination of one or more alkoxysilanes having an epoxy group in the molecule as defined above in an amount of from 1 to 6 wt. % of the composition and/or 1,3,5-tris[3-(trimethoxysilyl)propyl]-1,3,5-triazine-2,4,6(1H,3H,5H)-trione, with zirconium acetylacetonate in an amount of from 1 to 5 wt. % of the composition.

In one embodiment said alkoxysilanes having an epoxy group in the molecule is selected from 3-glycidoxypropyltrimethoxysilane, 3-glycidoxypropyltriethoxysilane, 3-glycidoxypropylmethyldiethoxysilane and/or 3-glycidoxypropylmethyldimethoxysilane.

Component (iv)(f)—Eco-Solvent

Component (iv)(f) of the 2-part hydrosilylation curable silicone topcoat composition is an eco-solvent, i.e., an environmental-friendly solvent with minimal, if any, hazardous effects which may be suitable use for applications such as in cosmetics products and excludes hazardous solvents such benzene, toluene and xylene. Any suitable eco-solvent may be utilised, examples include isopentadecane, isohexadecane, isoheptadecane, isooctadecane, isononadecane and mixtures thereof or trimethyl terminated polydimethylsiloxane having a viscosity of from greater than or equal to (≥)₅ mPa·s at 25 °C to less than or equal to (≤) 100 mPa·s at 25 °C. It has been noted that use of a trimethyl terminated polydimethylsiloxane having a viscosity of <5 mPa·s at 25 °C seems to result in a leather material which in fact does whiten in its stretch marks. In one embodiment the eco-solvent comprises or consists of isohexadecane. The eco-solvent is present in the composition as a means of diluting the composition and is present in the composition in an amount of from 30 to 70 wt. % of the 2-part hydrosilylation curable silicone topcoat composition. It may be present in either part or in both parts A and B, as desired or required.

Component (iv)(g) Optional Cured Silicone Elastomer Powder

When required any suitable cured silicone elastomer powder may be utilised in the 2-part hydrosilylation curable silicone topcoat composition. In one alternative, cured silicone elastomer powder (iv)(g) has an average particle size of from 0.01 to 100 μm, alternatively 0.01 to 50 μm, alternatively from 0.01 to 25 μm as measured e.g., using the Dow Silicone Corporation Corporate Test Method CTM 1138 which is available to the public upon request. They may contain chemically functional groups, e.g., epoxy groups (meth)acryloxy groups or may be coated e.g., with a silica treated coating.

The cured silicone elastomer powder is made from a suitable curable silicone composition. These may include, for example, addition (hydrosilylation) reaction-curing silicone compositions, condensation reaction-curing silicone compositions, organoperoxide-curing silicone compositions, and ultraviolet-curing silicone compositions. Addition reaction-curing and condensation reaction-curing silicone compositions are preferred for their ease of handling.

Silicone elastomer powders are generally prepared by making a homogeneous water-based emulsion of the curable silicone composition by first dispersing the curable silicone composition in water or an aqueous surfactant solution, and by then subjecting this dispersion to the action of an agitator such as a homogenizer, colloid mill, or a mixing device such as an ultrasonic vibrator. The water-based curable silicone emulsion is preferably prepared using surfactant to obtain a very stable emulsion in which the curable silicone composition has a small average particle diameter. A water-based dispersion of the cured silicone powder is then produced by curing the curable silicone present in the water-based emulsion. This cure may be affected by allowing said water-based emulsion to stand at room temperature or by heating the water-based emulsion. If heating the water-based curable silicone emulsion, the preferred heating temperature should not exceed 100 °C, while particularly preferred temperatures fall in the range of 40 °C to 95 °C. The techniques for heating the water-based curable silicone emulsion are by direct heating of the water-based emulsion or by adding the water-based emulsion to hot water. Commercial examples which may be utilised as component (iv)(g) include, for the sake of example, Dowsil™ 23N Additive, Dowsil™ 603T additive and Dowsil™ 9701 Cosmetic Powder from Dow Silicones Corporation.

The cured silicone rubber powder is present in the 2-part hydrosilylation curable silicone topcoat composition in an amount of from 2.5 to 20 wt. % of the composition, alternatively from 2.5 to 15 wt. % of the composition, alternatively from 2.5. to 10 wt. % of the composition, i.e., when part A and part B are mixed together.

### Optional Additives

The 2-part hydrosilylation curable silicone topcoat composition may comprise one or more additives. Examples of these optional additives include cure inhibitors, inorganic non-reinforcing fillers, electrically conductive additives, pot life extenders, lubricants, flame retardants, pigments, colouring agents, chain extenders, heat stabilizers, compression set improvement additives, antisqueak agents, antioxidants, antistatic agents, anti-soiling agents and light stabilizers, anti-freeze agents and/or biocides and mixtures thereof.

### Inhibitor

Optionally, to obtain a longer working time or pot life of the 2-part hydrosilylation curable silicone topcoat composition because a hydrosilylation cure system is being utilised, a suitable inhibitor may be incorporated into the composition in order to retard or suppress the activity of the catalyst. Inhibitors of platinum metal-based catalysts, generally a platinum metal-based catalyst is well known in the art. Hydrosilylation or addition-reaction inhibitors include hydrazines, triazoles, phosphines, mercaptans, organic nitrogen compounds, acetylenic alcohols, silylated acetylenic alcohols such as methyl (tris(1,1-dimethyl-2-propynyloxy))silane, maleates, fumarates, ethylenically or aromatically unsaturated amides, ethylenically unsaturated isocyanates, olefinic siloxanes, unsaturated hydrocarbon monoesters and diesters, conjugated ene-ynes, hydroperoxides, nitriles, and diaziridines. Alkenyl-substituted siloxanes as described in U.S. Pat. No. 3,989,667 may be used, of which cyclic methylvinylsiloxanes are preferred.

Another class of known inhibitors of platinum catalysts includes the acetylenic compounds disclosed in U.S. Pat. No. 3,445,420. Acetylenic alcohols such as 2-methyl-3-butyn-2-ol constitute a preferred class of inhibitors that will suppress the activity of a platinum-containing catalyst at 25 °C.

Hydrosilylation curable silicone elastomer compositions containing these inhibitors typically require heating at temperature of 70 °C. or above to cure at a practical rate.

Examples of acetylenic alcohols and their derivatives include 1-ethynyl-1-cyclohexanol (ETCH), 2-methyl-3-butyn-2-ol, 3-butyn-1-ol, 3-butyn-2-ol, propargyl alcohol, 3,5-dimethyl-1-hexyn-3-ol, 1-ethynylcyclopentanol, 1-phenyl-2-propynol, 3-methyl-1-penten-4-yn-3-ol, and mixtures thereof.

When present, inhibitor concentrations as low as 1 mole of inhibitor per mole of the metal of catalyst (iv)(d) will in some instances impart satisfactory storage stability and cure rate. In other instances, inhibitor concentrations of up to 500 moles of inhibitor per mole of the metal of catalyst (iv)(d) are required. The optimum concentration for a given inhibitor in a given composition is readily determined by routine experimentation. Dependent on the concentration and form in which the inhibitor selected is provided/available commercially, when present in the composition, the inhibitor is typically present in an amount of from 0.0125 to 10 wt. % of the 2-part hydrosilylation curable silicone topcoat composition. Mixtures of the above may also be used.

Where the optional additives may be used for more than one reason e.g., as a non-reinforcing filler and flame retardant, when present they may function in both roles. When or if present, the aforementioned additional components are cumulatively present in an amount of from 0.1 to 30 wt. %, alternatively of from 0.1 to 20 wt. % of the 2-part hydrosilylation curable silicone topcoat composition.

In order to prevent premature cure in storage, the 2-part hydrosilylation curable silicone topcoat composition will be stored prior to use in two-parts Part A and part B. Typically, part A will contain some of organopolysiloxane polymer (iv)(a) and reinforcing filler (iv)(b) as well as hydrosilylation catalyst (iv)(d) and part B will contain the remainder of organopolysiloxane polymer (iv)(a) and reinforcing filler (iv)(b) together with organohydrogenpolysiloxane cross-linker (iv)(c) and, usually if present, the inhibitor, but this can vary dependent on the choice of the inhibitor used. The two-part composition may be designed to be mixed together in any suitable ratio, dependent on the amounts of organopolysiloxane polymer (iv)(a) and reinforcing filler (iv)(b) in part B and as such can be mixed in a PartA:PartB weight ratio of from 15:1 to 1:2 but are preferably mixed in a PartA:PartB weight ratio of from 2:1 to 1:2, alternatively from 1.5:1 to 1:1.5, alternatively 1:1.

The 2-part hydrosilylation curable silicone topcoat composition is cured after mixing at a temperature of from 120 °C-175 °C, alternatively from 130 °C-160 °C for a period of from 2-8 minutes. The average dry coat thickness of the 2-part hydrosilylation curable silicone topcoat is from 5-20 μm.

Two suitable commercial examples of silicone topcoat layer (iv) are SILASTIC™ LX-2010 Top Coat and SILASTIC™ LX-2011 Top Coat, both of which are available from Dow Silicones Corporation.

The Silicone Leather Composite Material Carbinol Terminated Silicone/Polyurethane Hybrid Prepolymer Based Coating Layer Made from the Carbinol Terminated Silicone/Polyurethane Hybrid Prepolymer Based Coating Layer (v)

The carbinol terminated silicone/polyurethane hybrid prepolymer based coating layer (v) is provided by curing a suitable carbinol terminated silicone/polyurethane hybrid prepolymer based coating composition and when the silicone leather composite material is complete the silicone/polyurethane hybrid prepolymer based coating layer (v) is between skin layer (iii) and silicone topcoat layer (iv). The composition is prepared in a suitable solvent and the solvent evaporates during a heated curing process.

The average dry coat thickness of the carbinol terminated silicone/polyurethane hybrid prepolymer based coating layer (v) is between 10 μm to 50 μm. This was determined by measuring the length and width of a sample of release paper, coating the release paper with the carbinol terminated silicone/polyurethane hybrid prepolymer based coating composition, curing same, weighing the resulting release paper coated with carbinol terminated silicone/polyurethane hybrid prepolymer based coating layer (v) and calculating the average thickness on the basis of the following formula:

average dry coat thickness of layer(v)=weight layer(v)/(density*width*length)

The average dry coat thickness of each layer where given, was determined in an analogous fashion to the thickness of layer (v), by determining the weight of the respective layer and using the above formulation. In each case the density was determined in accordance with ASTM D792.

Preferably the silicone leather composite material as described herein contains a carbinol terminated silicone/polyurethane hybrid prepolymer based coating layer (v) having a modulus equal to or greater than 10 MPa determined in accordance with ASTM D882, alternatively equal to or greater than 20 MPa determined in accordance with ASTM D882, alternatively equal to or greater than 30 MPa determined in accordance with ASTM D882, in each instance using the initial linear portion of the load-extension curve to calculate the modulus.

As previously discussed, there is also provided a method for preparing the silicone leather composite material described herein. The process comprises the steps of
(a) Coating a release paper with a layer of carbinol terminated silicone/polyurethane hybrid prepolymer based coating composition and curing said composition to provide a carbinol terminated silicone/polyurethane hybrid prepolymer based coating layer (v);
(b) Applying a layer of a silicone skin composition on to the cured carbinol terminated silicone/polyurethane hybrid prepolymer based coating layer (v) and curing said composition to provide a silicone skin layer (iii);
(c) Applying a layer of silicone binder composition onto cured silicone skin layer (iii) and applying a textile layer (i) onto the silicone binder composition and curing and/or laminating said composition to form a silicone binder layer (ii) between said textile support layer (i) and said skin layer (iii);
(d) Removing the release paper from the cured carbinol terminated silicone/polyurethane hybrid prepolymer based coating layer (v); and
(e) Applying a layer of a 2-part hydrosilylation curable silicone topcoat composition onto the cured carbinol terminated silicone/polyurethane hybrid prepolymer based coating layer (v) and curing said topcoat composition to form a silicone topcoat layer (iv).

It was found that if the 2-part hydrosilylation curable silicone topcoat composition were applied onto the release paper as the first step of the process followed by the application of the carbinol terminated silicone/polyurethane hybrid prepolymer based coating composition (v) problems were encountered and therefore surprisingly the process described above was developed as the issues were avoided by adding the topcoat onto the cured carbinol terminated silicone/polyurethane hybrid prepolymer based coating layer (v) as a last step.

In one embodiment of the process for preparing the silicone leather composite material described herein, the process comprises the steps of
(a) Coating a release paper with a layer of carbinol terminated silicone/polyurethane hybrid prepolymer based coating composition and curing to form a carbinol terminated silicone/polyurethane hybrid prepolymer based coating layer (v) at a temperature of between 120 °C-180 °C for 2-10 minutes, to obtain an average dry coat thickness of from 10 μm to 50 μm using the method described above;
(b) Applying a layer of a silicone skin composition on to the cured carbinol terminated silicone/polyurethane hybrid prepolymer based coating layer (v) and curing at any suitable temperature, for example at 100 to 150 °C, to produce a silicone skin layer (iii) having an average dry coat thickness of from 50 μm to 1 mm, thick, 50 to 750 μm, alternatively 50 to 500 μm, alternatively 50 to 350 μm, alternatively 50 to 250 μm thick, alternatively 70 μm to 200 μm using the method described above;
(c) Applying a layer of a silicone binder composition onto cured silicone skin layer (iii) and applying a textile layer (i) onto the silicone binder and curing and/or laminating said silicone binder (ii) between said textile support layer (i) and said skin layer (iii) at a temperature of 130 °C-180 °C for 2-8 minutes with the thickness of the resulting layer being determined by the thickness requirement for the silicone leather composite material and the thickness of other layers;
(d) Removing the release paper from the cured carbinol terminated silicone/polyurethane hybrid prepolymer based coating layer (v); and
(e) Applying a layer of 2-part hydrosilylation curable silicone topcoat composition (iv) onto the cured carbinol terminated silicone/polyurethane hybrid prepolymer based coating layer (v) and curing said topcoat curing at 130 °C-160 °C for 2-8 minutes to form a silicone topcoat (v) having an average dry coat thickness of from 5-20 μm using the method described above and to complete the silicone leather composite material.

The individual parts of each 2-part hydrosilylation composition described above may be prepared in any way suitable. Any mixing techniques and devices described in the prior art can be used for this purpose. The particular device to be used will be determined dependent on the viscosities of components and the respective final curable composition. Suitable mixers include but are not limited to paddle type mixers e.g., planetary mixers and kneader type mixers. Cooling of components during mixing may be desirable to avoid premature curing of the composition. Hence as an initial step of the process the part A and Part B of each 2-part composition are mixed together and if desired e.g., in the case of the 2-part hydrosilylation compositions e.g., for the skin layer and binder layer the composition may be degassed.

The order for mixing components in the hydrosilylation curable silicone elastomer composition of the 2-part hydrosilylation curable silicone topcoat composition is not critical. Suitable parts A and B are prepared and then part A and part B are mixed together in a predetermined weight ratio between 15:1 and 1:2 e.g., for the sake of example, a 1:1 weight ratio shortly prior to use.

After preparation and/or mixing each composition utilised to provide the respective layers in the silicone leather composite material may be applied in accordance with the process above using any suitable method of application e.g., spraying, rolling, brushing, spin coating, dip coating, solvent casting, slot die coating, spray coating, knife coating, or gravure coating.

Any suitable release paper may be used for example super matting release paper ARX175DM from the Japan Asahi company, matting release paper DE-7, DE-90, DE-43C, DE-73J from the Dai Nippon Printing Co., Ltd of Japan or semi-matting release paper DE-73M also from the Dai Nippon Printing Co., Ltd of Japan.

Each cure step may take place in a suitable oven, e.g., by curing and drying in a hot-air oven or may be undertaken in a conveyor oven in the case of a continuous process.

If desired the final silicone leather composite material may be post cured at a temperature between about 75 °C and 180 °C, generally but not necessarily if desired towards the lower end of the range e.g., from 75 to 120 °C for from 2 to 48 hours, alternatively from 6 to 36 hours, alternatively from 10 to 24 hours.

The silicone leather composite material may be designed to have a wide variety of properties given the content of the different layers, e.g., they may have excellent flame retardancy, smoke density, heat resistance, contamination resistance, solvent resistance, hydrolysis resistance, and the like as required for the end use of the leather. However, the provision of the carbinol terminated silicone/polyurethane hybrid prepolymer based coating layer (v) resulted in a significant improved Gakushin abrasion resistance but also provided both a carbinol terminated silicone/polyurethane hybrid prepolymer and a carbinol terminated silicone/polyurethane hybrid prepolymer based coating composition (v) both of which were stable in storage prior to application and cure of said composition.

End uses envisaged include but are not limited to furniture, decoration, handbags, binders, luggage, garments, phone covers, covers for electronic goods, book covers, footwear, car interiors, car seats, medical beds/seats, wearable devices and the like.

### EXAMPLES

In the following examples and comparative examples several silicone leather composite materials were prepared and were tested to show the benefit of incorporating a carbinol terminated silicone/polyurethane hybrid prepolymer based coating layer (v) as a means of improving abrasion resistance. All viscosities are measured at 25 °C. Carbinol terminated PU-PDMS prepolymer viscosities were measured using a Brookfield™ rotational viscometer with spindle CPA-52Z for viscosities in the range between 10,000-400,000 mPa·s. Other viscosities were measured using a Brookfield™ rotational viscometer with spindle LV-62 for viscosities in the range between 15-10,000 mPa·s and a rotation speed of 10 rpm unless otherwise indicated. The amount (wt. %) of unsaturated groups and/or silicon bonded hydrogen present was determined using quantitative infra-red analysis in accordance with ASTM E168.

A series of examples of carbinol terminated silicone/polyurethane hybrid prepolymers and comparative —NCO terminated silicone/polyurethane hybrid prepolymers were prepared.

Materials utilised in the preparation of the prepolymer include:

isophorone diisocyanate (IPDI) of the following structure:

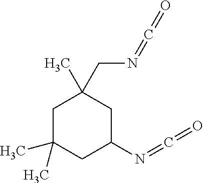 [SMILES: CC1(C)CC(N=C=O)CC(C)(CN=C=O)C1]

Carbinol terminated Polydimethylsiloxane (PDMS) was a monoethylene glycol terminated polydimethylsiloxane, having a viscosity of about 48 mPa·s at 25 °C and about 60 mg KOH/g as measured in accordance with ASTM-D4274-11.

The Bi/Zn Catalyst was an organic Bismuth/Zinc complex catalyst designed to catalyze reaction of —NCOs group with —OH groups for polyurethane products and is commercially available under the trade name BX-EM 23 from Guangzhou Yourun Synthetic Material Co., Ltd of Guang Dong, China; The solvent used was dipropylene glycol methyl ether acetate (DPMA); The polyether triol used in the examples has an average molecular weight of 260 and is commercially available under the trade name VORANOL™ CP 260 Polyol from the Dow Chemical company;

The amounts of each starting ingredient used are provided in Tables 1a and 1c below and details regarding the prepolymers prepared are provided in Tables 1b and 1d respectively.

TABLE 1a
Starting ingredients for making comparative
silicone/polyurethane hybrid prepolymers

| | C. 1 | C. 2 | C. 3 |
|---|---|---|---|
| Isophorone diisocyanate (IPDI) | 26.01 | 33.54 | 17.01 |
| 1,4-butanediol | 4.41 | 7.42 | 6.08 |
| Carbinol terminated PDMS | 37.53 | 27.00 | 49.82 |
| Bi/Zn Catalyst | 0.08 | 0.08 | 0.06 |
| DPMA | 31.97 | 31.96 | 25.81 |
| Polyether triol | | | 1.22 |
| Total dosage | 100.00 | 100.00 | 100.00 |

The comparative prepolymers of the compositions in Table 1a were prepared using the following process. The Isophorone diisocyanate (IPDI), solvent 1,4-butanediol, carbinol terminated PDMS and/or polyether triol are thoroughly mixed together with the dipropylene glycol methyl ether acetate, DPMA solvent in a reaction kettle and then the Zn/Bi catalyst was gradually added. The OH:NCO molar ratio was greater than 1.15:1. The resulting mixture was heated to about 70° C and then continuously stirred at that approximate temperature for a further three hours before cooling down to 30~40 °C and was finally packed into a container or storage or as in the present examples the resulting prepolymer product was immediately used in the preparation of a silicone/polyurethane hybrid prepolymer based coating composition by being missed with the other ingredients of the composition in solution. The solvent evaporates however during the cure process.

The resulting prepolymer details are indicated in Table 1b.

TABLE 1b
Details of_comparative silicone/polyurethane
hybrid prepolymer made in Table 1a.

| | C. 1 | C. 2 | C. 3 |
|---|---|---|---|
| —OH:—NCO molar ratio | 0.5895 | 0.641 | 1.229 |
| —OH or —NCO terminated? | NCO | NCO | OH |

A series of example prepolymers was also prepared using the compositions given in Table 1c and their details are provided in Table 1d below.

TABLE 1c
Starting ingredients for making examples silicone/
polyurethane hybrid prepolymers (wt. %)

| | Ex. 1 | Ex. | Ex. 3 | Ex. 4 | Ex. 5 | Ex. 6 |
|---|---|---|---|---|---|---|
| Isophorone | 23.32 | 23.29 | 24.99 | 21.86 | 22.63 | 25.07 |
| diisocyanate | | | | | | |
| (IPDI) | | | | | | |
| 1,4-butanediol | 9.39 | 9.38 | 10.06 | 8.80 | 9.48 | 10.46 |
| Carbinol | 33.24 | 33.20 | 35.62 | 31.17 | 37.64 | 35.74 |
| terminated PDMS | | | | | | |
| Bi/Zn Catalyst | 0.07 | 0.20 | 0.07 | 0.06 | 0.08 | 0.07 |
| DPMA | 33.31 | 33.26 | 28.55 | 37.49 | 30.17 | 28.66 |
| Polyether triol | 0.67 | 0.67 | 0.71 | 0.62 | | |
| Total Dosage | 100 | 100 | 100 | 100 | 100 | 100 |

TABLE 1d
Details of example silicone/polyurethane
hybrid prepolymers made in Table 1a.

| | Ex. 1 | Ex. | Ex. 3 | Ex. 4 | Ex. 5 | Ex. 6 |
|---|---|---|---|---|---|---|
| OH/—NCO molar ratio | 1.20 | 1.20 | 1.20 | 1.20 | 1.23 | 1.198 |
| —OH or —NCO terminated? | OH | OH | OH | OH | OH | OH |

The same process was utilised for each composition in Tables 1a and 1c.

In Tables 2a and 2b the viscosity characteristics of the prepolymers made from the compositions in Tables 1a and 1c were compared before and after aging.

TABLE 2a
Viscosity characteristics of comparative prepolymers
prepared from the compositions of Table 1a

| | C. 1 | C. 2 | C. 3 |
|---|---|---|---|
| Fresh viscosity, (mPa · s at 25 °C) | 565 | 4085 | 8533 |
| Viscosity after aging at 50 °C for | Gelled | Gelled | 8731 |
| 2 weeks (mPa · s at 25 °C) | | | |

TABLE 2b
Viscosity characteristics of Example prepolymers
prepared from the compositions of Table 1c

| | Ex. 1 | Ex. | Ex. 3 | Ex. 4 | Ex. 5 | Ex. 6 |
|---|---|---|---|---|---|---|
| Fresh viscosity, | 58500 | 60500 | 220700 | 21910 | 25480 | 95730 |
| (mPa · s at 25° C.) | | | | | | |
| Viscosity after | 57470 | 67870 | 230000 | 22150 | 26050 | 94860 |
| aging at 50° C. for | | | | | | |
| 2 weeks | | | | | | |
| (mPa · s at 25° C.) | | | | | | |

The Viscosities measured for Tables 2a and 2b were undertaken using a Brookfield™ rotational viscometer with spindle CPA-52Z for viscosities in the range between 10,000-400,000 mPa·s.

Other viscosities were measured using a Brookfield™ rotational viscometer with spindle LV-62 for viscosities in the range between 15-10,000 mPa·s and a rotation speed of 10 rpm. It can be seen that the comparative prepolymers which were —NCO terminated both gelled during aging. CE. 3 and the examples in accordance with the disclosure herein from Table 2b all showed only small viscosity changes after the aging period. Hence it can be unexpectedly seen that by utilising carbinol terminated polymers the prepolymer is able to age much longer without significant increase in viscosity or gelling during storage unlike similar —NCO terminated prepolymers.

The resulting prepolymers prepared as described in Tables 1a to 1d using the process described above were then prepared into comparative silicone/polyurethane hybrid prepolymer based compositions using the starting ingredients depicted in Tables 3a and 3b.

TABLE 3a
Comparative silicone/polyurethane hybrid prepolymer
based compositions using the comparative prepolymers
made per Tables 1a and 1b.

| | C. 1 | C. 2 | C. 3 |
|---|---|---|---|
| PU-PDMS hybrid Prepolymer dosage | 100.00 | 100.00 | 100.00 |
| DPMA | | | 24.30 |
| Resinous SiH crosslinker | 4.03 | 4.03 | 3.26 |
| Polyurethane microparticles | 13.24 | 13.24 | 10.69 |
| Karstedt's catalyst | 0.015 | 0.015 | 0.01 |
| Crosslinker 1 | | | 18.42 |
| Crosslinker 2 | 8.01 | 8.01 | |
| PU-PDMS hybrid prepolymer —OH | NCO | NCO | OH |
| or —NCO terminated? | | | |
| OH:—NCO molar ratio in hybrid | 1.00 | 1.00 | 1.00 |
| topcoat layer (Prepolymer | | | |
| reacting with crosslinker) | | | |

In the above compositions in Table 3a (as well as Table 3b below) the amounts of the ingredients are given in parts by weight per 100 parts by weight of the respective silicone/polyurethane hybrid prepolymer. The materials not previously identified which were used to make the prepolymer compositions are as follows.

The resinous SiH crosslinker is an Si—H dimethyl terminated resinous Si—H polysiloxane having a viscosity of 25 mPa·s at 25 °C and a silicon bonded hydrogen content of about 9,000 ppm;

The Polyurethane microparticles used in the compositions have an average particle size 1-10 μm (supplier information) are commercially available under the trade name RHU-5070D Polyurethane microparticles from Dainichiseika Color & Chemicals Mfg. Co. Ltd;

Crosslinker 1 is Desmodur™ Z 4470 BA which is 70% IPDI trimer (structure below) in n-butyl acetate and is commercially available as Desmodur™ Z 4470 BA from Covestro AG.

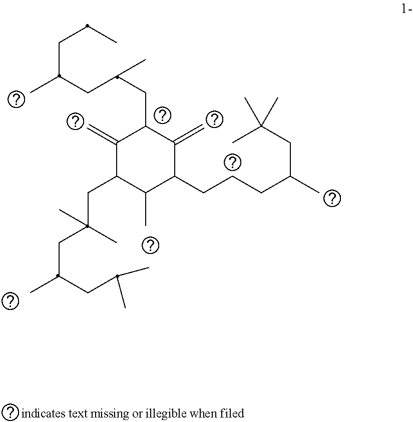 [SMILES: C=C1C(CC(C)CC(C)CCC)C(=C)C(CC(C)(C)CC(C)CC(C)C)C(C)C1CCCC(C)CC(C)(C)C]

Cross-linker 2 is the polyether triol described above with an average molecular weight of 260 and is commercially available under the trade name VORANOL™ CP 260 Polyol from The Dow Chemical Company.

In the above when making —NCO terminated silicone/polyurethane hybrid prepolymer based compositions (C. 1 and 2), the appropriate NCO-terminated silicone/polyurethane (PU-PDMS) hybrid prepolymer is mixed with cross-linker 2 (at a NCO:OH molar ratio of 0.95-1.05), together with the polyurethane microparticles, resinous SiH crosslinker and Karstedt's catalyst to form a carbinol terminated silicone/polyurethane hybrid prepolymer based coating composition in readiness for application as a layer in the composite silicone leather material.

In the case of C. 3 the carbinol terminated silicone/polyurethane hybrid prepolymer is mixed with cross-linker 1 (at a NCO:OH molar ratio of 0.95-1.05), together with the polyurethane microparticles, resinous SiH crosslinker, and Karstedt's catalyst to form the carbinol terminated silicone/polyurethane hybrid prepolymer based coating composition in readiness for application as a layer in the composite silicone leather material.

TABLE 3b
silicone/polyurethane hybrid prepolymer based compositions
using the example made per Tables 1c and 1d.

| | Ex. 1 | Ex. | Ex. 3 | Ex. 4 | Ex. 5 | Ex. 6 |
|---|---|---|---|---|---|---|
| PU-PDMS hybrid Prepolymer dosage | 100.00 | 100.00 | 100.00 | 100.00 | 100.00 | 100.00 |
| DPMA | 26.65 | 26.62 | 35.69 | 18.74 | 37.72 | 35.82 |
| Resinous SiH crosslinker | 3.57 | 3.57 | 3.83 | 3.35 | 4.04 | 3.84 |
| Polyurethane microparticles | 11.73 | 11.71 | 12.56 | 10.99 | 13.28 | 12.61 |
| Karstedt's catalyst | 0.013 | 0.013 | 0.014 | 0.012 | 0.015 | 0.014 |
| Crosslinker 1 | 15.17 | 15.15 | 16.25 | 14.22 | 17.18 | 16.31 |
| PU-PDMS hybrid prepolymer-OH | OH | OH | OH | OH | OH | OH |
| or —NCO terminated? | | | | | | |
| OH/—NCO molar ratio in | 1.00 | 1.00 | 1.00 | 1.00 | 1.00 | 1.00 |
| hybrid topcoat layer (Prepolymer | | | | | | |
| reacting with crosslinker) | | | | | | |

In the case of the examples above each composition was made using an analogous process to that of the one for the C. 3 prepolymer described above.

In order to test the abrasion resistance of silicone leather composite materials containing a layer s of the different silicone/polyurethane hybrid prepolymer based coatings made using the coating compositions shown in Tables 3a and 3b above each silicone/polyurethane hybrid prepolymer based coating composition prepared above was used in a sample silicone leather composite material which was prepared as follows:
(a) Coating a release paper with a layer of silicone/polyurethane hybrid prepolymer based coating composition as prepared using the compositions detailed in Tables 3a or 3b above. and curing to form a silicone/polyurethane hybrid prepolymer based coating layer (v) at a temperature of between 120 °C-180 °C for 2-10 minutes, to obtain an average dry coat thickness of from 10 m to 50 μm using the method described above;
(b) Applying a layer of a silicone skin composition using commercially available SILASTIC™ LX-2351 LSR on to the cured silicone/polyurethane hybrid prepolymer based coating layer (v) and curing at any suitable temperature, between 100 to 150 °C to produce a silicone skin layer (iii) having an average dry coat thickness of from 70 μm to 200 μm using the method described above;
(c) Applying a layer of a silicone binder composition in the form of SILASTIC™ LX-2401 LSR onto cured silicone skin layer (iii) and applying a textile layer (i) onto the silicone binder and curing and/or laminating said silicone binder (ii) between said textile support layer (i) and said skin layer (iii) at a temperature of between 130 °C-180 °C for 2-8 minutes with an average dry coat thickness of from 200 μm to 250 μm for silicone binder layer (ii) using the method described above;
(d) Removing the release paper from the cured silicone/polyurethane hybrid prepolymer based coating layer (v); and
(e) Applying a layer of SILASTIC™ LX-2011 Top Coat as a top-coat preferably using gravure to provide a topcoat which upon cure provides a good hand-feel, and good soil resistance. curing said topcoat curing at 130 °C-160 °C for 2-8 minutes to form a silicone topcoat (v) having an average dry coat thickness of from 5-20 m using the method described above and to complete the silicone leather composite material.

Each resulting silicone leather composite material made using the above process was tested for their abrasion resistance. The abrasion resistance of each resulting silicone leather composite material was tested with on a Gakushin Model: GT-7020 from GOODTECHWILL Testing Machines Co., Ltd.

The silicone leather composite materials were cut into rectangular shapes measuring 10×100 mm and then fitted to the weighted test heads of the Gakushin Model: GT-7020 with double-sided tape. The abrasive action is provided by pieces of cotton abrasive fabric (JIS L3102 6 #, 30 mm*250 mm) placed onto the movable curved platen of the Gakushin instrument. The platen moves back and forth at 30 cycles/minute with the total weight of each head being 1 kg. Testing was stopped every 2000 cycles and the effect on the surface of the leather composite was observed and noted

TABLE 4a
Gakushin abrasion Performance Testing of C. 1 to C. 3

| | C. 1 | C. 2 | C. 3 |
|---|---|---|---|
| Gakushin abrasion of Silicone | 5000 | 8000 | 1500 |
| leather with PU-PDMS hybrid | | | |
| prepolymer (cycles) | | | |

C. 1 and C. 2 were observed to have almost gelled after three months aging at room temperature (25 °C) and had clearly gelled after aging at 50 °C for 2 weeks (Table 2a). That said the Gakushin abrasion results were acceptable. In contrast, it was found that whilst the viscosity of C. 3 hardly changed after aging at 50 °C for 2 weeks (measured in mPa·s at 25 °C) (Table 2a) but when applied as a layer in a the silicone leather composite as described herein the silicone leather gave poor Gakushin abrasion results which it is believed was due to the composition containing too low a level of IPDI and too much Carbinol terminated polydimethylsiloxane.

TABLE 4b
Gakushin abrasion Performance Testing of Ex. 1 to 6

| | Ex. 1 | Ex. | Ex. 3 | Ex. 4 | Ex. 5 | Ex. 6 |
|---|---|---|---|---|---|---|
| Gakushin abrasion of Silicone leather with | 7000 | 10000 | 12000 | 6000 | 8000 | 12000 |
| PU-PDMS hybrid prepolymer (cycles) | | | | | | |

Each of Ex. 1 to Ex. 6 were observed to have a good shelf life of greater than 12 months aging at room temperature (25 °C) and the viscosity of the prepolymers hardly changed after aging at 50 °C for 2 weeks (measured in mPa·s at 25 °C) (Table 2b), with no gelling observed. Furthermore, they all gave good Gakushin abrasion results.

What is claimed is:

1. A method of preparing a carbinol terminated silicone/polyurethane hybrid prepolymer based coating composition comprising the steps of
(A) Preparing a carbinol terminated silicone/polyurethane hybrid prepolymer by mixing together
(I) A diisocyanate in an amount of 20 to 30 wt. % of the step (A) starting ingredients,
(II) an alkane diol chain extender in an amount of from 5 to 15 wt. % of the step (A) starting ingredients
(III) a carbinol terminated polydimethylsiloxane in an amount of from 25 to 45 wt. % of the step (A) starting ingredients
(IV) a Solvent in an amount of from 20 to 40 wt. % of the step (A) starting ingredients, and optionally
(V) a polyether triol in an amount of up to 2 wt. % of the step (A) starting ingredients
wherein the molar ratio of OH:NCO is greater than 1.15:1;
by gradually introducing a suitable catalyst while heating the mixture to a predetermined reaction temperature of from 60 to 90 °C and continuing to stir the mixture for a pre-determined time of at least 90 minutes whilst maintaining the mixture at the predetermined reaction temperature and then cooling the reaction product of carbinol terminated silicone/polyurethane hybrid prepolymer; and
(B) preparing the carbinol terminated silicone/polyurethane hybrid prepolymer based coating composition (v) by mixing
(v)(a) the carbinol terminated silicone/polyurethane hybrid prepolymer with
(v)(b) optional cured silicone elastomer powder;
(v)(c) optional silicon-free organic particles and/or microparticles selected from at least one of polymethyl methacrylate (PMMA), ethylene-vinyl acetate copolymer (EVA), ethylene-acrylate copolymer (EAA), ethylene-butyl acrylate copolymer (EBA), ethylene-methyl acrylate copolymer (EMA), ethylene-ethyl acrylate copolymer (EEA) or polyurethane polymer;
(v)(d) a polyorganosiloxane containing at least two or alternatively at least three silicon bonded hydrogen (—Si—H) groups per molecule present in an amount of from 1 wt. %-10 wt. % of the composition;
(v)(f) a polyisocyanate crosslinker having three or more isocyanate groups per molecule in an amount such that the molar ratio of —OH groups of (v)(a) to —NCO groups in (v)(f) in the carbinol terminated silicone/polyurethane hybrid prepolymer based coating composition (v) is from 0.95:1 to 1.05:1; and
(v)(g) a platinum group metal-based catalyst.

2. The method of preparing a carbinol terminated silicone/polyurethane hybrid prepolymer based coating composition in accordance with claim 1, wherein a polyurethane cure catalyst (v)(e) is also added into the carbinol terminated silicone/polyurethane hybrid prepolymer based coating composition.

3. A carbinol terminated silicone/polyurethane hybrid prepolymer based coating composition obtained or obtainable by the method of claim 1.

4. The carbinol terminated silicone/polyurethane hybrid prepolymer based coating composition in accordance with claim 3, comprising
(v)(a) the carbinol terminated silicone/polyurethane hybrid prepolymer with
(v)(b) optional cured silicone elastomer powder;
(v)(c) optional silicon-free organic particles and/or microparticles selected from at least one of polymethyl methacrylate (PMMA), ethylene-vinyl acetate copolymer (EVA), ethylene-acrylate copolymer (EAA), ethylene-butyl acrylate copolymer (EBA), ethylene-methyl acrylate copolymer (EMA), ethylene-ethyl acrylate copolymer (EEA) or polyurethane polymer;
(v)(d) a polyorganosiloxane containing at least two or alternatively at least three silicon bonded hydrogen (—Si—H) groups per molecule present in an amount of from 1 wt. %-10 wt. % of the composition;
(v)(f) a polyisocyanate crosslinker having three or more isocyanate groups per molecule in an amount such that the molar ratio of —OH groups of (v)(a) to —NCO groups in (v)(f) in the carbinol terminated silicone/polyurethane hybrid prepolymer based coating composition (v) is from 0.95:1 to 1.05:1; and
(v)(g) a platinum group metal-based catalyst.

5. The carbinol terminated silicone/polyurethane hybrid prepolymer based coating composition in accordance with claim 4 wherein the silicone/polyurethane hybrid prepolymer based coating composition additionally comprises a polyurethane cure catalyst (v)(e).

6. A method of preparing a carbinol terminated silicone/polyurethane hybrid prepolymer by mixing together
(I) a diisocyanate in an amount of 20 to 30 wt. %;
(II) an alkane diol chain extender in an amount of from 5 to 15 wt. %;
(III) a carbinol terminated polydimethylsiloxane in an amount of from 25 to 45 wt. %;
(IV) a Solvent in an amount of from 20 to 40 wt. %;
(V) a polyether triol in an amount of up to 2 wt. %,
wherein the weight percent values are relative to the total weight of the components (I) to (V); and
wherein the molar ratio of OH:NCO is greater than 1.15:1; by gradually introducing a suitable catalyst while heating the mixture to a predetermined reaction temperature of from 60 to 90 °C and continuing to stir the mixture for a pre-determined time of at least 90 minutes whilst maintaining the mixture at the predetermined reaction temperature and then cooling the reaction product of carbinol terminated silicone/polyurethane hybrid prepolymer.

7. A carbinol terminated silicone/polyurethane hybrid prepolymer obtained or obtainable from the method of claim 6 herein.

8. (canceled)

9. A silicone leather composite material comprising
(i) A textile support layer;
(ii) A silicone binder, wherein the silicone binder is the cured product of a 2-part hydrosilylation curable silicone rubber composition designed to adhere to the textile support layer (i) and the skin layer (iii), which has a shore A hardness of from 20 to 40 measured in accordance with ASTM D2240;
(iii) A silicone skin layer, wherein the silicone skin layer is the cured product of a 2-part hydrosilylation curable silicone rubber composition comprising an adhesion promoter, which silicone skin layer has a shore A hardness greater than or equal to (≥) 50 when measured in accordance with ASTM D2240;
(iv) a silicone topcoat layer wherein the silicone topcoat layer is the cured product of a 2-part hydrosilylation curable silicone topcoat composition which comprises an adhesion promoter; and
(v) a silicone/polyurethane hybrid prepolymer based coating layer which is the cured product of the silicone/polyurethane hybrid prepolymer based coating composition in accordance with claim 3;
wherein the silicone binder (ii) is adhered between textile support (i) and the skin layer (iii), the skin layer (iii) is between the silicone binder layer (ii) and the silicone/polyurethane hybrid prepolymer based coating layer and silicone topcoat layer (iv) is on the silicone/polyurethane hybrid prepolymer based coating layer (v).

10-12. (canceled)

13. A method of preparing the silicone leather composite material in accordance with claim 9 comprising the steps of:
(a) coating a release paper with a layer of the carbinol terminated silicone/polyurethane hybrid prepolymer based coating composition and curing said composition to provide the carbinol terminated silicone/polyurethane hybrid prepolymer based coating layer (v);
(b) Applying a layer of the 2-part hydrosilylation curable silicone rubber composition on to the cured carbinol terminated silicone/polyurethane hybrid prepolymer based coating layer (v) and curing said 2-part hydrosilylation curable silicone rubber composition to provide the silicone skin layer (iii);
(c) Applying a layer of the 2-part hydrosilylation curable silicone rubber composition onto the cured silicone skin layer (iii) and applying the textile support layer (i) onto the 2-part hydrosilylation curable silicone rubber composition and curing and/or laminating said 2-part hydrosilylation curable silicone rubber composition to form the silicone binder layer (ii) between said textile support layer (i) and said skin layer (iii);
(d) Removing the release paper from the cured carbinol terminated silicone/polyurethane hybrid prepolymer based coating layer (v); and
(e) Applying a layer of the 2-part hydrosilylation curable silicone topcoat composition onto the cured carbinol terminated silicone/polyurethane hybrid prepolymer based coating layer (v) and curing said 2-part hydrosilylation curable silicone topcoat composition to form the silicone topcoat layer (iv).

14. The method in accordance with claim 13 wherein the silicone/polyurethane hybrid prepolymer based coating composition is cured at a temperature of from 120 °C to 180 °C for 2-10 minutes, to obtain an average dry coat thickness of from 10 μm to 50 μm using the method described herein.

15. The method in accordance with claim 13 wherein the 2-part hydrosilylation curable silicone topcoat composition is cured at a temperature of from at 130 °C-160 °C for 2-8 minutes to form the silicone topcoat layer (iv) having an average dry coat thickness of from 5-20 μm using the method disclosed in the description.

16. (canceled)
